(19) United States
(12) Patent Application Publication
(10) Pub. No.: US 2006/0199061 A1
(43) Pub. Date: Sep. 7, 2006

(54) Water management in bipolar electrochemical cell stacks

(76) Inventors: Bradley N. Fiebig, Bryan, TX (US); Alan J. Cisar, Cypress, TX (US); Oliver J. Murphy, Bryan, TX (US); Daniel F. Houy, Caldwell, TX (US); Nicole L. Williams, Portland, OR (US)

Correspondence Address: STREETS & STEELE, 13831 NORTHWEST FREEWAY, SUITE 355, HOUSTON, TX, 77040, US

(21) Appl. No.: 11/358,707

(22) Filed: Feb. 21, 2006

Related U.S. Application Data
(60) Provisional application No. 60/657,820, filed on Mar. 2, 2005.

(51) Int. Cl. H01M 8/24; H01M 8/10; H01M 4/94; H01M 8/04

(52) U.S. Cl. 429/32; 429/44; 429/38; 429/22; 429/26; 429/13; 429/34

(57) ABSTRACT

A bipolar, filter press-like electrochemical cell stack comprising a plurality of electrochemical cells, where each electrochemical cell is supplied with a gaseous anodic reactant and either supplied with a gaseous cathodic reactant or produces a gaseous cathodic product, and where each electrochemical cell avoids drying out the ion exchange membrane polymer electrolyte, avoids flooding at the cathode, facilitates recovery of liquid water at the anode, and reduces water losses from at least one of the electrodes. A water retention barrier is variously positioned, such as between a gas diffusion electrode and a fluid flow field. The barrier may be either: (i) a thin, gas permeable, liquid water impermeable membrane; (ii) a thin, porous sheet of material; or (iii) a thin, substantially solid sheet of material except for a plurality of small through-holes that penetrate from one side of the sheet to an opposing side of the same sheet. The barrier is advantageously used at the cathode and facilitates air cooling of the cell.

This application claims priority to U.S. Provisional Patent Application Ser. No. 60/657,820, filed on Mar. 2, 2005.

### BACKGROUND OF THE INVENTION

1. Field of the Invention

The present invention relates to bipolar filter press-like electrochemical cell stacks supplied with gaseous reactants, preferably with an oxidizing gas (oxidant) and a reducing gas (reductant) and the operation of such electrochemical cell stacks.

2. Background of the Related Art

Fuel cells are a type of electrochemical cell that produces electrical energy as a result of electrochemically combining chemical reactants, commonly referred to as a fuel and an oxidant, within the fuel cells and producing at least one chemical product as well as releasing thermal energy. In a fuel cell, electrical energy is produced due to electrochemical oxidation reactions and electrochemical reduction reactions taking place within the fuel cell. A fuel cell can use hydrogen gas as a fuel (or reductant) along with oxygen gas or air as an oxidant which will be transformed electrochemically within the fuel cell to produce electrical energy along with water so long as the fuel and oxidant are supplied to the fuel cell. The water thus produced is commonly referred to as “product water”.

Other chemical oxidants (besides oxygen or air) and chemical reductants (besides hydrogen) can be used in electrochemical cells. For instance, in the case of fuel cells typical chemical reductants (or fuels) would include methanol, ethanol, formic acid, dimethyl ether, hydrazine, and ammonia, while typical chemical oxidants would include hydrogen peroxide, nitric acid, chlorine, and bromine. However, the most suitable fuel for fuel cells is hydrogen gas, preferably pure hydrogen gas. Suitable sources of pure hydrogen gas include compressed hydrogen gas in high pressure cylinders, hydrogen gas stored within the lattice of suitably contained metal alloys (known in the art as metal hydrides), and hydrogen contained in chemical hydrides, such as sodium borohydride, lithium hydride, calcium hydride, etc. Hydrogen gas can be released from chemical hydrides on carrying out either hydrolysis or thermolysis processes. An advantage of the hydrolysis process is that the hydrogen released from chemical hydrides is humidified as it is produced.

Electrochemical hydrogen concentrators are another example of electrochemical cells that utilize components identical to fuel cells and function in a manner that is similar to fuel cells that are also supplied with at least one gaseous reductant. These electrochemical devices are also known as electrochemical hydrogen pumps.

In order to function, an electrochemical cell comprises an anode and a cathode, separated by an electrolyte. The electrolyte can consist of an ionically conducting aqueous solution, such as, aqueous potassium hydroxide, or aqueous sulfuric acid. However, it is more convenient if the electrolyte is in the form of an ion exchange membrane, either a cation exchange membrane or an anion exchange membrane. Ion exchange membranes can be in the form of thin, flexible organic polymer materials or thin, rigid ceramic materials. Typically, organic polymer cation exchange membrane materials can be homogeneous polymers as represented by the Nafion® family made by DuPont of Wilmington, Del., or polymer composites comprising a support matrix impregnated with the cation exchange polymer material as represented by the Gore Select® family of membranes made by W.L. Gore & Associates, Elkington, Md. Ion exchange polymer membranes used in electrochemical cells typically have thicknesses in the range of 20-200 μm. An attractive form of a cation exchange membrane as a solid polymer electrolyte for use in electrochemical cells is a proton (H⁺) exchange membrane (PEM). Similarly, an attractive form of an anion exchange membrane as a solid electrolyte for electrochemical cells includes hydroxyl ion (OH⁻) exchange membranes (HIEM) and oxide ion (O²⁻) exchange membranes (OIEM). As is well known to one skilled in the art, “ion exchange membranes,” “cation exchange membranes,” and “anion exchange membranes” are also referred to as “ion conducting membranes,” “cation conducting membranes” and “anion conducting membranes,” respectively.

In general, thin, flexible organic polymer ion exchange membranes used as solid polymer electrolytes in electrochemical cells are limited to operating temperatures of less than 100° C. at pressures close to atmospheric pressure since ion conduction through these membranes requires that the membranes be at least partially saturated with water in the liquid phase. Thus, in order for Nafion®-like proton exchange membranes to conduct protons from the anode, through the thickness of a proton exchange membrane to the cathode, it is necessary for such membranes to be wet with liquid water. This water has been provided from various sources in the past, including humidification of the anode reactant gas, humidification of the cathode reactant gas, and by back diffusion of liquid water if produced at the cathode, through the proton exchange membrane towards the anode.

During operation of an electrochemical cell supplied with gaseous reactants, e.g., hydrogen gas as the fuel at the anode and oxygen gas (or air) as the oxidant at the cathode, organic polymer proton exchange membranes can become sufficiently dehydrated either at the anode electrocatalyst/membrane interface, the cathode electrocatalyst/membrane interface, or throughout the bulk thickness of the membrane such that cell performance can be greatly reduced and degradation or decomposition of the membrane takes place. Dehydration of a membrane can occur almost uniformly over the electrochemically active plane of the membrane or in localized regions of the active plane. One mechanism that leads to drying of a proton exchange membrane is referred to as electroosmotic drag. As protons pass from the anode to the cathode through the proton exchange membrane each proton drags water molecules surrounding the proton, or within its hydration sheath, with it towards the cathode. Accordingly, this drying effect occurs throughout operation of a fuel cell or an electrochemical gas concentrator that are supplied with gaseous reactants. Furthermore, this drying effect is relatively proportional to the current density experienced by the fuel cell or electrochemical gas concentrator during operation of such devices. The dehydrating effects due to this mechanism of drying have the greatest impact on the performance of a fuel cell or an electrochemical gas concentrator at the anode electrocatalyst/membrane interface.

A second mechanism of drying a proton exchange membrane solid polymer electrolyte in an electrochemical cell is associated with the characteristics of the anode reactant gas and cathode reactant gas (if any) introduced into the cell. If these reactant gases are not almost fully humidified at the operating temperatures and pressures of the electrochemical cell, the membrane can dry out at either the anode electrocatalyst/membrane interface, the cathode electrocatalyst/membrane interface, or at both electrocatalyst/membrane interfaces. The dehydrating effects as a result of this mechanism will be more pronounced the greater the flow rate of the dry, or partially humidified, reactant gases supplied to the electrochemical cell. Furthermore, membrane drying effects arising from this mechanism will tend to be non-uniform in the plane of the membrane and will be more pronounced at the points of introduction of the reactant gas(es) into the electrochemical cell. Therefore, the extent of drying of a proton exchange membrane in an electrochemical cell depends upon various factors, including the physical design, or structure, of the cell and the operating conditions in which the cell is used.

While the PEM, or at least the anode electrocatalyst/membrane interface, is subject to drying the cathode electrocatalyst/membrane interface can be the subject of flooding. Flooding is a term used to describe the situation when liquid water covers reaction sites on the electrocatalyst layer, and/or saturates the gas diffusion layer in contact with the electrocatalyst layer, such that most of a reactant gas is blocked from accessing the electrocatalyst sites. The flooding of the cathode in an electrochemical cell is effected by several factors, including the rate of water generation at the cathode (in the case of a fuel cell), the rate of electroosmotic water transfer from the anode through the proton exchange membrane to the cathode, and the operating conditions of the electrochemical cell including temperature, pressure, reactant gas stoichiometry, and the extent of humidification of the reactant gas.

An electrochemical hydrogen gas concentrator includes a proton exchange membrane with a hydrogen anode electrocatalyst and a hydrogen cathode electrocatalyst in intimate contact with the membrane on opposing sides of the membrane. Under an applied electrical potential from an external DC power supply, a humidified hydrogen-containing gas is supplied to the anode electrocatalyst where the reactant hydrogen gas molecules are dissociated to form protons and electrons. The protons pass through the proton exchange membrane to the cathode electrocatalyst and the electrons pass through an external circuit to the cathode electrocatalyst also. At the cathode electrocatalyst/proton exchange membrane interface, the protons and electrons recombine to form purified hydrogen gas molecules. In the process, the protons transport water derived from the consumed, humidified reactant hydrogen gas with them from the anode compartment to the cathode compartment due to electroosmotic drag. A smaller amount of water may also be transported from the anode compartment, through the proton exchange membrane to the cathode compartment by diffusion. Efficient operation of an electrochemical hydrogen gas concentrator requires passive water management in the concentrator and recovery of any liquid water, preferably from the anode compartment, which can be achieved by the present invention.

Fuel cells can be designed to facilitate electrochemical reactions taking place at fast rates utilizing gaseous reactants, e.g., hydrogen gas and oxygen gas (or air), to produce electrical energy and product water. However, in some instances, such as to achieve fast reaction rates, it has been found to be advantageous to externally humidify the reactant hydrogen gas and/or reactant oxygen gas (or air), prior to separately introducing them to a fuel cell. Depending on the operating temperature and pressure of a fuel cell, the product water formed can primarily be in the liquid phase or in the vapor phase. A proton exchange membrane fuel cell includes an anode and a cathode in intimate contact with opposing sides of a proton exchange membrane. During operation of such a fuel cell, the anode electrocatalyst layer transforms hydrogen gas molecules into electrons and protons. The electrons are collected by means of a current collector in contact with the anode electrocatalyst layer and are passed through an external circuit that is connected to the cathode current collector. The protons formed by the anodic reaction at the anode electrocatalyst/proton exchange membrane interface pass through the proton conducting membrane solid electrolyte from the anode to the cathode. Protons and electrons delivered to the cathode electrocatalyst layer along with oxygen gas molecules (or air) normally delivered through flow channels react to form product water at the cathode electrocatalyst/proton exchange membrane interface. In this manner, the fuel cell is used to produce a useful electrical current in the external circuit and high purity product water.

During the operation of PEM fuel cells, it is essential that a proper water balance be maintained between a rate at which water is produced at the cathode electrode and rates at which water is removed from the cathode and at which water is supplied to the anode electrode. An operational limit on performance of a fuel cell is defined by an ability of the cell to maintain the water balance as electrical current drawn from the cell into the external load circuit varies and as an operating environment such as the surrounding temperature of the cell varies. For a PEM fuel cell, if insufficient water is returned to the anode electrode, adjacent portions of the PEM electrolyte dry out thereby decreasing the rate at which protons may be transferred through the PEM and also resulting in cross-over of the reducing fuel gas, which is typically hydrogen or a hydrogen rich gas, leading to local over heating. Thus, drying out or localized loss of water, in particular at a reactant inlet, can ultimately result in the development of cracks and/or holes in a proton exchange membrane. These holes allow the mixing of the hydrogen and oxygen reactants, commonly called “cross over,” with a resultant chemical combustion of cross over reactants; loss of electrochemical energy efficiency; and localized heating. Such localized heating can further promote the loss of water from the proton exchange membrane and further drying out of the membrane, which can accelerate reactant cross over. Similarly, if insufficient water is removed from the cathode, the cathode electrode may become flooded effectively limiting oxidant supply to the cathode electrocatalyst and hence decreasing current flow. Additionally, if too much water is removed from the cathode by the oxidant gas stream, the cathode may dry out limiting the ability of protons to pass through the PEM, thus decreasing cell performance.

Several approaches have been considered for dealing with the problem of removing product water from the active area of a stack of electrochemical cells such as a fuel cell stack. One approach is to evaporate the product water into the oxidant gas stream. This approach has a disadvantage in that it requires that the incoming oxidant gas be almost unsaturated so that the product water (and any water dragged from the anode to the cathode) will evaporate into the unsaturated oxidant gas stream.

In a PEM fuel cell, or in a PEM fuel cell stack, that employs the aforesaid water removal approach, the flow rate of the oxidant gas stream must be sufficiently high to ensure that the oxidant gas stream does not become saturated with water vapor within the flow path across the active area of a cell or cells. Otherwise, saturation of the oxidant gas stream in the flow path across the active area will prevent evaporation of the product and drag water and leave liquid water at the cathode gas diffusion electrode/flow path interface. This liquid water will prevent access of oxidant gas to the active sites of the cathode electrocatalyst thereby causing an increase in cell polarization, i.e., mass transport polarization, and a decrease in fuel cell performance and efficiency. Another disadvantage with the removal of product and drag water by evaporation through the use of an unsaturated oxidant gas stream is that the proton conducting membrane itself may become dry, particularly at the oxidant gas inlet of a cell.

A second approach for removing product and drag water from the cathode side of fuel cells involves the entrainment of the product and drag water as liquid droplets in the fully saturated flowing oxidant gas stream. This approach requires high flow rates of the oxidant gas stream to sweep the product water off the surface of the cathode electrode area through the flow field. Where air is the oxidant gas stream, these high flow rates require a large air circulation system and may cause a decrease in the utilization of the oxidant, i.e., in the fraction of reactant (oxygen) electrochemically reduced to form water. A decrease in the utilization of the oxidant gas lowers the overall efficiency of the fuel cell and requires a larger capacity pump and/or blower to move the oxidant gas stream through the flow field in order to entrain the product water. At very high current densities, oxidant utilizations as low as 5% may be necessary to remove the product water.

As previously mentioned, two techniques for maintaining sufficient hydration at the anode electrocatalyst/membrane interface for a PEM fuel cell supplied with gaseous anodic and cathodic reactants include humidification of the fuel gas and back diffusion of product water from the cathode through the proton exchange membrane to the anode. Conversely, for PEM fuel cells there has been much attention given to discharging or removing water from the cathode either as liquid water or as water vapor. Cathode gas diffusion layers are made at least partly hydrophobic so as to expel liquid water from the cathode electrocatalyst/gas diffusion electrode interface to the gas diffusion electrode/flow field interface and to provide water unsaturated regions within the gas diffusion electrode in which the reactant gas can access the cathode electrocatalyst sites. One technique that has been used in order to withdraw water as water vapor involves flowing an excessive amount of a reactant gas through the cathode flow field of the fuel cell, where the cathode flow field is physically in contact with, and exposed to, the back surface of the cathode gas diffusion layer. However, this technique has its drawbacks. For example, high reactant gas flow rates may require a significant consumption of energy, thereby reducing the overall efficiency of the fuel cell system. Still further, the complexity or efficiency of some fuel cell designs has not been optimized.

With another technique described in U.S. Pat. Nos. 5,260,143 and 5,366,818, liquid water accumulated at the cathode is removed by maintaining a partial pressure of water vapor in the hydrogen-containing gas supply below the saturation pressure of water vapor therein such that water accumulated at the cathode is drawn by a concentration gradient toward the anode across the proton exchange membrane and is absorbed as water vapor into the hydrogen-containing gas supply between the inlet and the outlet of the fuel cell. Liquid water accumulated at the cathode can also be removed by maintaining a partial pressure of water vapor in the oxygen-containing gas supply below the saturation pressure of water vapor therein such that water accumulated at the cathode is absorbed as water vapor into the oxygen-containing gas supply between the inlet and the outlet of the fuel cell.

An internal water management and transfer system is described in U.S. Pat. Nos. 5,853,909, 5,700,595, and 5,503,944. The system comprises porous bipolar plate/reactant gas flow field assemblies interposed between and in contact with adjacent proton exchange membrane and electrode assemblies. A water coolant circulating system is formed in each of the porous plate assemblies to allow each of the porous plate assemblies to become saturated with coolant water. The reactant flow fields are pressurized to achieve a selected ΔP so as to ensure that product water formed on the cathode side of each membrane/electrode assembly will be pumped through the porous plates into the coolant water flow field and become entrained in the circulating coolant water stream. However, due to the constraints placed on water transport plates, such as pore size, resistivity, particle size, resin content and yield strength, these plates are costly to manufacture and possess limited strength.

An electrolyte dry-out barrier to restrict loss of water from the electrolyte in a fuel cell is described in U.S. Pat. No. 6,521,367. The fuel cell has an anode catalyst and a cathode catalyst secured to opposing sides of an electrolyte, porous bipolar plate/flow field assemblies having a water coolant circulating system formed in each of the porous plate assemblies that cause each of the porous plate assemblies to become saturated with water, and an anode electrolyte dry-out barrier secured between the electrolyte and the anode flow field for restricting transfer of water from the electrolyte into the anode flow field. The anode electrolyte dry-out barrier extends from a reducing gas fluid inlet along a reducing gas fluid flow path a distance that is adequate for the reducing gas fluid stream flowing through the anode flow field to become saturated with water. The fuel cell may also include a cathode electrolyte dry-out barrier secured between the electrolyte and the cathode flow field. The anode and cathode electrolyte dry-out barriers may be formed by applying a coating or a film to a porous electrocatalyst support and/or gas diffusion layer, or water transport plate, between the electrolyte and the respective anode or cathode flow field. The coating or film may consist of dry-out barrier materials, compatible with a working environment of a fuel cell, such as a plastic, polymer, elastomer, or resin material with low water absorption properties, a ceramic, or a metal. Additionally, the porous electrocatalyst support or gas diffusion layer may be impregnated with dry-out barrier materials. By providing the fuel cell with anode and cathode electrolyte dry-out barriers, the fuel cell may receive very dry reducing gas and oxidizing gas streams having a zero percent relative humidity without fear of drying out the electrolyte adjacent the reducing gas and oxidizing gas inlets.

A means of discharging fuel cell product water on the anode side of a PEM fuel cell is described in U.S. Pat. No. 6,576,358. The means comprises a first porous, electron-conducting layer less than 300 μm in thickness disposed on the anode and a second porous, electron-conducting layer less than 300 μm in thickness disposed on the cathode. The second layer on the cathode side is hydrophobic and has a smaller pore size than the first layer on the anode side. The second layer, which can include a support matrix, is formed of an aerogel or a xerogel comprising carbon. The gas-permeable, liquid water impermeable, layer in the form of a carbon aerogel or carbon xerogel/cellulose membrane composite is covered with a smooth skin which has a thickness from about 3 to 4 μm and a pore size≦30 nm. As product water is formed at the cathode electrocatalyst/proton exchange membrane interface it is forced through the proton exchange membrane to the anode where it is removed by means of an excess reducing gas stream from the fuel cell. However, the relatively thick first and second porous layers restrict reactant gas transport to the electrocatalysts/membrane interfaces, especially the transport of air to the cathode electrocatalyst/membrane interface in a system operating at pressures near ambient, and increase the electrical resistance of the fuel cell.

U.S. publication 2004/0028974 discloses a polymer electrolyte membrane fuel cell provided with an internal humidification system comprising at least a first layer and a second layer, wherein the first layer comprises an electrically non-conductive, air permeable, water absorbent layer that stores water in close proximity to the membrane and is disposed adjacent, or in close proximity, to a cathode gas diffusion layer or a cathode current collector. The second layer comprises a water non-absorbent material disposed adjacent, or in close proximity, to the first layer, the second layer having through openings therein to allow passage of air through the second and first layers to the fuel cell interior.

The first layer comprises a porous, hydrophilic, woven or non-woven, fibrous material in the form of a sheet and may comprise a cloth, with cotton, other natural fibers or absorbent synthetic fibers being particularly suitable. The water non-absorbent material of the second layer, of the order of 0.1 mm in thickness, may be in the form of a substantially solid structure forming an impervious barrier or shell, except for the through openings that are provided to permit inflow of air. The through openings may comprise preformed passageways or holes or may be subsequently provided as perforations that extend from one surface of the second layer to its opposite surface to allow air to pass through the second layer. The preferred size and number of through openings in the second layer is such that a balance is reached between an adequate supply of air (oxygen) to the cathode and efficient retention of water in the vicinity of the polymer electrolyte membrane. This maintains the humidity of the membrane, and hence its conductivity. The open surface area in the second layer is typically between 1% and 10% of the surface. The water non-absorbent material can be a metal, a polymer, or a composite such as Kevlar® and is preferably a rigid material.

A method and apparatus for water management in a direct oxidation fuel cell system, that is for a fuel cell supplied with an aqueous solution of an organic compound, e.g., aqueous methanol, is described in U.S. publication 2003/0165720. The direct oxidation fuel cell includes a housing surrounding an anode, a cathode, a proton exchange membrane electrolyte disposed between the anode and the cathode, a current collector, and a gas-permeable liquid-impermeable membrane, preferably a membrane such as expanded polytetrafluoroethylene (PTFE), disposed on a side of the cathode opposite the electrolyte. Excess water accumulation, together with any other fluids, are removed from an area between the membrane electrolyte and the gas-permeable, liquid-impermeable membrane by a pressure differential generated, preferably by a pump, and are collected. The pressure differential draws air to the surface of, into, or through the cathode diffusion layer disposed between the cathode and the gas-permeable liquid-impermeable membrane.

However, there is still a need for an improved electrochemical cell structure or design, where the electrochemical cell is either a fuel cell or an electrochemical hydrogen concentrator supplied with hydrogen gas or a hydrogen-containing gas as a reductant, that is suitable for satisfying in a passive manner, under a broad range of cell operating conditions one or more of the following requirements: (i) avoidance of drying out at the anode electrocatalyst/proton exchange membrane interface; (ii) avoidance of flooding at the cathode electrocatalyst/proton exchange membrane interface; (iii) maximizing the recovery of liquid water from the anode compartment of the electrochemical cell; and (iv) minimizing the evaporation of water from the cathode compartment. It would be desirable if the fuel cell or electrochemical hydrogen concentrator did not rely on external humidification of reactant gases or high reactant gas flow rates. It would be even more desirable to have an electrochemical cell structure or design that did not dry out under operating conditions of elevated temperature at atmospheric pressure or subatmospheric pressure at ambient temperatures and did not require active water management or active liquid water recovery systems.

### BRIEF DESCRIPTION OF THE DRAWINGS

FIGS. 1(a)-(c) are diagrams illustrating various geometrical configurations for a water retention barrier of the present invention.

FIG. 2(a) is a schematic cross-sectional side view of three adjacent electrochemical cells (such as fuel cells or electrochemical hydrogen concentrator cells) from a PEM bipolar filter press-like stack where each cell is externally electrically connected in series to an adjacent cell.

FIG. 2(b) is a schematic cross-sectional side view of the electrochemical cells of FIG. 2(a) having a water retention barrier inserted into each cell between the cathode gas diffusion layer and the oxidant flow field.

FIG. 2(c) is a schematic cross-sectional side view of the electrochemical cells of FIG. 2(a) having a water retention barrier inserted into each cell between the anode gas diffusion layer and the reductant flow field.

FIG. 2(d) is a schematic cross-sectional side view of the electrochemical cells of FIG. 2(a) having a water retention barrier inserted into each cell between the anode gas diffusion layer and the reductant flow field and also between the cathode gas diffusion layer and the oxidant flow field.

FIGS. 3(a)-(g) are schematic cross-sectional side views of various configurations of gas diffusion layers suitable for incorporation in electrochemical cells of the type shown in FIGS. 2(a)-(d).

FIG. 4(a) is a schematic cross-sectional side view of segments of three adjacent electrochemical cells (such as fuel cells or electrochemical hydrogen concentrator cells) from a PEM bipolar filter press-like stack where each cell is internally electrically connected in series to an adjacent cell by an electronically conducting bipolar plate/flow field/current collector assembly.

FIG. 4(b) is a schematic cross-sectional side view of the electrochemical cells of FIG. 4(a) having a water retention barrier inserted into each cell between the cathode gas diffusion layer and the oxidant flow field.

FIG. 4(c) is a schematic cross-sectional side view of the electrochemical cells of FIG. 4(a) having a water retention barrier inserted into each cell at the position located between the anode gas diffusion layer and the reductant flow field.

FIG. 4(d) is a schematic cross-sectional side view of the electrochemical cells of FIG. 4(a) having water retention barriers inserted into each cell between the anode gas diffusion layer and the reductant flow field and also between the cathode gas diffusion layer and the oxidant flow field.

FIG. 5 is a cross-sectional side view of a subassembly that includes a water retention barrier, an air filtration layer and a structural support member.

FIG. 6 is a side view of a bipolar separator plate/flow field/current collector assembly for use in a bipolar filter press-like electrochemical cell stack, shown in partial cross-section.

FIG. 7 is a schematic diagram of a segment of a bipolar filter press-like fuel cell stack with an air or oxidant supply line in communication with the plurality of cathode flow fields through a common, external air filter media.

### DETAILED DESCRIPTION OF THE PREFERRED EMBODIMENTS

The present invention provides an electrochemical cell (or an electrochemical cell stack) supplied with a gaseous anodic reactant and either supplied with a gaseous cathodic reactant or producing a gaseous cathodic product. The cell avoids drying out at the anode electrocatalyst/ion exchange membrane interface, avoids flooding at the cathode electrocatalyst/ion exchange membrane interface, facilitates recovery of liquid water from the electrochemical cell at the anode compartment, and at the same time hinders the vaporization of water from the cathode. The electrochemical cell of the present invention is either a fuel cell or an electrochemical hydrogen gas concentrator where the fuel cell or the concentrator is supplied with a source of hydrogen gas as a reactant at the anode. In the case of the fuel cell, the gaseous oxidant is oxygen gas (or air), chlorine gas, or bromine gas. In the electrochemical hydrogen concentrator, the cathodic product is hydrogen gas. In the fuel cell of the present invention, the ion exchange membrane can be either a cation exchange membrane, such as a proton (H⁺) conducting membrane, or an anion exchange membrane, such as a hydroxyl ion (OH⁻) conducting membrane. In the electrochemical hydrogen concentrator of the present invention, the ion exchange membrane is preferably a proton conducting membrane. The present invention also provides an electrochemical cell that experiences reduced evaporative water losses from at least one of the electrodes. Evaporative water losses are reduced by disposing a water retention barrier at some position over the electrocatalyst/ion exchange membrane interface of an electrochemical cell, such as between a gas diffusion electrode and a gas flowfield that provides a reactant gas supply or removes a product gas exhaust. The water retention barrier may be either: (i) a thin, gas permeable, liquid water impermeable membrane; (ii) a thin, porous sheet of material; or (iii) a thin, substantially solid sheet of material except for a plurality of small through-holes that penetrate from one side of the sheet to an opposing side of the same sheet. Any one or any combination of these types of gas permeable or gas accessible barriers can be disposed between either the anode electrocatalyst and the anode reactant gas stream or the cathode electrocatalyst and the cathode reactant and/or product gas stream; however, the barriers are most advantageously used at the cathode side of an electrochemical cell.

In the case of a water retention barrier comprising a gas permeable, liquid water impermeable membrane, a particularly preferred membrane is a thin sheet of polytetrafluoroethylene (PTFE), such as having a thickness from 0.1 micron to 20 microns, more preferably from 0.3 to 5 microns, most preferably from 0.5 to 1 micron. These membranes are nonporous, but gas permeable. Other polymers, including fully fluorinated polymers, partially fluorinated polymers and other gas permeable polymers, that act as a membrane that is permeable to the relevant gases may also be used. It is anticipated that some polymer membranes might need to be supported on a macroporous or perforated material. If not made from a hydrophobic material, the membrane may be further coated preferably with a material which renders at least one surface of the membrane hydrophobic. A further benefit is that these membranes might exhibit some degree of selectivity to the passage of oxygen over nitrogen, argon, carbon dioxide or other gases part of, or suspended in, the air. Such selectivity might provide a fuel cell with additional performance benefits. A membrane that is selective to oxygen would also be expected to withhold water.

In the case of a water retention barrier comprising a porous sheet of material, such as a sheet of expanded polytetrafluoroethylene (PTFE), the pores may correspond to those classified as mesopores (average pore diameter between 2 nanometers and 50 nanometers) and/or macropores (average pore diameter greater than 50 nanometers) and have various pore densities per unit area of the sheet. The degree of porosity (or pore density) of the porous sheet of material will affect the performance of the electrochemical cell. A highly porous material readily facilitates the transport of a reactant gas to, or a product gas from, an electrocatalyst/ion exchange membrane interface, but also increases the loss of water due to evaporation. Conversely, a low porosity material aids in preventing the loss of water from the electrochemical cell due to evaporation, but impedes access of a reactant gas to an electrocatalyst/ion exchange membrane interface. The porous retention barriers of the present invention have an average pore size between 2 and 500 nanometers, such as between 20 and 200 nanometers and a thickness in the range 25 microns to 250 microns (0.001 inches to 0.010 inches). This range of pore sizes allows the barrier to be freely accessible or permeable to a reactant gas and/or product gas, such as oxygen, air, or other cathode reactive gases as well as water vapor in the case of a fuel cell, or product hydrogen gas as well as water vapor in the case of an electrochemical hydrogen gas concentrator. The porous sheet may comprise a woven or non-woven fibrous material, or may be formed from a plurality of fine individual fibers that have been compacted or sintered, or may be formed from one or more expanded sheets of a solid material. Still further, the porous sheet may be made from metal foam comprising open cells, perhaps crushed and/or impregnated with particulate and/or colloidal PTFE to obtain the desired pore size. Any of the porous sheets may be further coated, preferably with a material which renders at least one surface of the sheet hydrophobic.

In the case of a water retention barrier comprising a thin, substantially solid sheet of material, a plurality of small diameter through-holes extending from one surface to an opposing surface facilitate the transport of air (or oxygen) to an electrocatalyst/ion exchange membrane interface. The through-holes may be selected from one or more geometrical shapes including, without limitation, circular, square, rectangular, triangular, diamond, oval, pentagonal, hexagonal, or heptagonal. Still further, the sheet may consist of a metal foil etched to produce a porous sheet. Alternatively, the through-holes may be in the form of slots or slits. The preferred size of the through-holes and the number of the through-holes per unit area of the solid sheet will be determined on the one hand by the need to maintain an adequate supply of air (or oxygen) to the electrocatalyst/ion exchange membrane interface and on the other hand by the requirement to maintain water in the electrochemical cell, in particular water within the ion exchange membrane. To satisfy these demands of the electrochemical cell, the total area associated with the through-holes will normally be in the range of 1% to 20% of the geometric area of the solid sheet, where the geometric area of the solid sheet corresponds to the geometric area of an electrode in the electrochemical cell. The substantially solid sheet can be either rigid or flexible and may optionally have a thickness in the range of 25 microns to 250 microns (0.001 inches to 0.010 inches), but it could be much thicker. Advantageously, some or all of the surface (optionally including the walls of the through-holes) of the substantially solid sheet water retention barrier that is adjacent the cathode electrode (or the anode electrode as the case may be) is preferably coated or treated so that it is made hydrophobic. Such a treatment may involve brushing or spraying with a halogenated polymer solution to give a thin film of the dried or cured polymer material on the surface. Where the barrier is a metal sheet with through-holes or metal foam comprising open cells, the barrier may be coated with quasicrystals, such as through a process of electrocodeposition as described in copending U.S. patent application Ser. No. 10/824,183, which is incorporated by reference herein, in order to make the barrier highly hydrophobic and to reduce the pore size.

All fuel cells that utilize proton exchange membranes as solid polymer electrolytes produce product water at their cathodes as shown by equation 2, below. In addition to the product water produced at the cathode, more water is delivered to the cathode by the electroosmotic drag of the protons that are transported through the thickness of the membrane from the anode compartment to the cathode compartment. However, in a fuel cell supplied with hydrogen gas as fuel and oxygen gas (or air, or oxygen-enriched air as the source of oxygen) as the oxidant, the transfer of water by electroosmotic drag from the anode compartment to the cathode compartment is typically balanced by the Fickian diffusion of water from the cathode to the anode. This is the case particularly for fuel cells that use relatively thin (e.g., 10-50 micron) proton exchange membranes as solid polymer electrolytes. There is essentially no net water transfer from the anode to the cathode and, in the absence of excessive evaporation, the hygroscopic proton exchange membrane retains sufficient water to maintain high proton conductivity.
H₂→2H⁺+2e⁻ (Anode Reaction) Equation 1
2H⁺+½O₂+2e⁻→H₂O (Product Water) (Cathode Reaction) Equation 2

The electrolyte between the anode and the cathode may be an acidic solution, phosphoric acid, sulfuric acid, an aqueous solution, an alkaline solution, a solution of potassium hydroxide, a polymer with sulfonic acid functionalities or other acid functionalities. An exemplary polymer electrolyte has sulfonic acid functionalities that may be partially or fully halogenated, such as with fluorine.

While the liquid water retention barrier of the present invention does allow water vapor to pass through it, the barrier restricts the volume or amount of water vapor drawn into the bulk of the gases outside the electrode structure, such as the reactant gas as it passes through an electrochemical cell flow field in contact with the barrier, or the product gas that is being exhausted out of the cell. This barrier facilitates more water remaining in contact with the proton exchange membrane which improves membrane conductivity, hence, minimizing heat generation within the electrochemical cell. Lowering the amount of heat generated within the electrochemical cell maintains a greater fraction of the product water and/or electroosmotic water in the liquid phase at any given operating pressure. In turn, a larger amount of water at the cathode in the liquid phase gives rise to enhanced back diffusion of water from the cathode, through the proton exchange membrane to the anode. In addition, transferring water to the anode gas stream makes it possible to recover excess water from the anode for use elsewhere in the electrochemical cell stack or even outside the stack. In general, it is simpler to recover water from the anode compartment at all times, than from an oxidant stream comprised of air, which is typically drawn from, and released to, the environment.

The liquid water retention barrier of the present invention can take various positions within an electrochemical cell. For example, the barrier may be disposed between a flow field and a gas diffusion electrode, within a gas diffusion electrode, or between the gas diffusion electrode and the adjacent electrocatalyst layer on one side of a proton exchange membrane. Regardless of the exact positioning of the barrier within the layered structure of the electrochemical cell, the barrier should cover most, if not all, of the electrochemically active surface area of an electrode. The liquid water retention barrier may be either completely electronically conductive, have some regions which are electronically conductive and other regions which are electronically non-conductive, or be completely electronically non-conductive (electronically insulating). Whether or not the barrier must be electronically conductive depends on where the barrier is located or positioned relative to the electronic current path. If the barrier (or a portion of the barrier) is in a location that would normally be in the electronic current path, then it will generally be electronically conductive. If the barrier is in a location not normally in the current path it will generally be electronically non-conductive. While the retention barrier may find suitable use in, or attached to, the anode compartment, it is generally preferred to use the barrier in relation to the cathode, or the cathode compartment, and not the anode. The cathode side of an electrochemical cell, or cathode compartment, presents the best opportunity to retain water within an electrochemical cell having an acidic electrolyte, such as a fuel cell containing a proton exchange membrane, because product water is produced at the cathode and electroosmotic water is delivered to the cathode. By retaining liquid water within the cell there is less need for make-up water and/or humidification of the reactant gas streams. Still, depending on the physical and/or chemical characteristics of the barrier it may allow sufficient water vapor losses to avoid flooding of the cathode. In addition, the physical and/or chemical characteristics of the barrier are sufficient to avoid restricting the flow of oxygen (or air) to the cathode to support the cathode reactions.

The liquid water retention barrier may be made from any suitable material including, without limitation, a porous thermoplastic, other porous polymer sheet or film, expanded PTFE, other expanded polymer sheet or film, filter paper, perforated polymer film, perforated metal sheet or foil, etched metal sheet or foil, micro expanded metal sheet or foil, porous sintered metal frits, metal felts, metal foams comprising open cells, porous metal oxide sheet such as aluminum oxide, polymer felts, polymer foams comprising open cells, carbon aerogels, resorcinol-formaldehyde aerogels, porous ceramic frits, ceramic felts, or perforated ceramic sheet, other similar materials, or combinations thereof. Non-halogenated thermoplastics useful in this invention include, but are not limited to, polyethylene, polypropylene, polystyrene, polycyclopentadiene, polyester, polycarbonate, polyethersulfone, polyimides, the various nylons, other similar compounds, and combinations thereof. Halogenated thermoplastics useful in this invention include polytetrafluoroethylene (PTFE), polyvinylidene fluoride (PvDF), polyvinylflouride (PVF), polyvinylchloride (PVC), other similar compounds, and combinations thereof. These and other polymers may be used alone, in combination with each other, or in combination with other modifiers, such as carbon or powdered metal, to produce composites with special properties, such as electronic conductivity, stiffness, rigidity, flexibility, etc. Metal composites or composites of metals with nonmetals, such as oxides, may also be used and may be especially useful when some combination of desirable properties can be obtained form the blend that cannot be obtained from any of its pure components. Other compositions useful for forming the barriers of this invention will be apparent to those skilled in the art after gaining an understanding of the present invention.

In the case of a water retention barrier comprising a porous sheet of material, the preferred full average pore size in the liquid water retention barrier is between 20 and 500 nanometers, more particularly between 50 and 500 nanometers, and most preferably between 100 and 500 nanometers. Optionally, perforations may be formed by etching, laser drilling, and other methods available to those skilled in the art.

The liquid water retention barrier may be made more resistant to liquid water transmission by coating the retention barrier, for example making the barrier hydrophobic. Hydrophobic pores resist water blockage. The barrier may be made hydrophobic through the use of inherently hydrophobic materials to fabricate the barrier or by partially or fully coating the barrier with a hydrophobic material, such as partially or fully fluorinated polymers including PTFE or certain hydrocarbon-based polymers, or by electrocodeposition of a layer comprising quasicrystals. The barrier can be fabricated by adding a modifier, such as PTFE or PvDF, to modify the pore structure, such as with the pore structure of polymer foam or metal foam comprising open cells. Other suitable liquid water retention barriers include thin sheets of microporous polypropylene (such as CELGARD®) and other separators known for use in batteries. A liquid water retention barrier may be made in any suitable thickness, but is preferably between 10 and 500 micrometers (0.4 and 20 mils or 0.0004 and 0.020 inches) in thickness. A solid gas permeable barrier or membrane may need to be as thin as 0.1 micrometer. In one embodiment, the liquid water retention barrier is prepared from a liquid dispersion that forms a porous layer upon evaporating, curing, sintering or solidifying. Still further, the liquid water retention barrier may be a composite structure, such as an organic/inorganic composite including organic/metallic and metallic/oxide composites.

In one embodiment of this invention, the liquid water retention barrier is produced from a material (pure phase or composite) that has high elasticity and flexibility and a coefficient of thermal expansion that is at least 30% different from the adjacent structural materials in the stack. For example, the barrier might be prepared with a thermoresponsive polymer hydro gel composed of poly(vinyl alcohol) and poly(acrylic acid). If the barrier is physically constrained (such as by adhering the barrier to an electrode structure) and expands more on heating than the rest of the stack, then the result will be a barrier with pores that become smaller at higher temperatures, thereby impeding water losses through evaporation. If the barrier is physically constrained and expands less on heating than the rest of the stack, then the pores will become larger at higher temperatures, thereby promoting increased gas exchange and water vapor losses. In another embodiment of this invention, the pores in the barrier are lined with a polymer that changes its hydrophobicity with temperature. Examples of this type of material are described in U.S. Pat. No. 6,699,611, which patent is incorporated by reference herein. These embodiments regulate the flow of moisture out of the electrode compartment by making the barrier more resistant to the passage of water as the temperature rises (a negative thermo-responsive polymer).

One particular advantage of using the water retention barrier in a bipolar, filter press-like electrochemical cell stack is that a high airflow rate may be used without drying the cathodes. A large excess of air is useful for cooling the stack without the need for separate cooling fluids and passageways.

The water retention barriers of the invention may be beneficially used with any bipolar, filter press-like electrochemical cell stack that includes a proton exchange membrane, an anode electrocatalyst layer, a cathode electrocatalyst layer, and typically a pair of gas diffusion layers disposed over the anode electrocatalyst layer and the cathode electrocatalyst layer. Suitable proton exchange membranes are well known to one skilled in the art and include NAFION® (a trademark of Dupont of Wilmington, Del.) which is a perfluorinated sulfonic acid polymer. The anode and cathode electrodes typically comprise an electrocatalyst layer or thin film applied to either surface of the proton exchange membrane. Such electrocatalysts typically include platinum, ruthenium, other precious metals or alloys including these metals. The catalyst can be used neat, in the form of a powder or metal black, or supported on another material, preferably a conductive material. Regardless of the form that the catalyst is in, it is generally compounded with a binder to keep it in the desired position. Examples of gas diffusion layers include waterproofed porous carbon paper, electronically conductive carbon felts, carbon cloth impregnated with carbon powder, expanded metal sheets impregnated with carbon powder and/or carbon fibers, woven and non-woven metal cloths impregnated with carbon powder and/or carbon fibers, and metal foams comprising open cells impregnated with carbon powder and/or carbon fibers. Any or all of these layers may include further treatments, coatings, modifiers, or configurations that assist in their operation. For example, the electrocatalyst layer may be mixed with certain amounts of perfluorinated sulfonic acid polymer solutions and the carbon powder and/or carbon fibers comprising the gas diffusion layer may be mixed with polytetrafluoroethylene to make regions of a gas diffusion layer hydrophobic.

Gas diffusion electrodes, their construction and fabrication are generally described in U.S. Pat. Nos. 5,460,705 and 6,733,913, which patents are incorporated by reference herein. Conventional carbon cloth-supported gas diffusion electrodes have a gas diffusion matrix consisting of conductive carbon powder bound together, and to the carbon cloth, by PTFE. Gas diffusion electrodes of this type (ELAT™ Gas Diffusion Layers) are manufactured and sold under the part numbers LT 1200-W, LT 1400-W, and LT 2500-W by DeNora North America, Inc., Somerset, N.J. Similar gas diffusion electrodes, such as SIGRACET® Gas Diffusion Media are manufactured and sold under the part numbers GDL10-BA, GDL30-BA, and GDL31-BA by the SGL Carbon Group, Charlotte, N.C. and the Carbel® CL Gas Diffusion Media by W.L. Gore & Associates, Inc., Elkton, Md. Related gas diffusion electrodes comprising AvCarb™ Carbon Fiber Papers are manufactured and sold under the part numbers P50T and P75T by Ballard Material Products, Inc., Lowell, Mass., and Toray™ Carbon Paper (PTFE treated) are manufactured and sold under the part number EC-TP1-060T by Electrochem, Inc., Woburn, Mass. Such gas diffusion electrodes are useful in some electrochemical cell stacks that incorporate one or more embodiments of this invention.

For other electrochemical cell stacks that incorporate one or more embodiments of this invention a gas diffusion electrode is made by mixing Vulcan XC-72R high surface area carbon powder (available from CABOT Technology Division, Pampa, Tex.) with polytetrafluoroethylene “PTFE” suspension (such as T-30, available from DuPont, Wilmington Del.) in a range of 45-70 weight percent carbon powder and 30-55 weight percent polytetrafluoroethylene such as a 60:40 ratio (based on the dry weight of the PTFE), water, and a nonionic surfactant (such as Triton X 100, available from Fisher Scientific, Fair Lawn, N.J.). The carbon/PTFE mixture is sonicated to reach complete dispersion and the resulting paste is spread onto a fluid permeable metal support/current collector, such as, an expanded metal foil, perforated or etched metal sheet, metal foam having open cells, or woven or non-woven metal wire cloth.

The fluid permeable metal support/current collector may be selected from titanium, nickel, copper, stainless steels, tin and tin alloys including copper-tin alloys, aluminum and aluminum alloys, or magnesium and magnesium allows. Before being coated with the paste comprising the gas diffusion electrode matrix, a suitable fluid permeable metal support/current collector may be coated with a layer of a metal, metal oxide, metal nitride, or metal carbide to protect it from corrosion and/or oxidation phenomena under the operating conditions of an electrochemical cell stack. Electrodeposition, chemical vapor deposition or sputtering are suitable processes for applying a layer of metal, metal oxide, metal nitride, or metal carbide to a metal support/current collector. The metal forming the coating can be selected from tin and tin alloys, silver and silver alloys, copper and copper alloys, gold and gold alloys, or bismuth. Suitable metal oxides include tin oxide (preferably doped with indium or fluorine), 30 mole % ruthenium dioxide/70 mole % titanium dioxide, and the mixed suboxides of titanium, e.g., Ti₂O₃, Ti₃O₅, Ti₄O₇, Ti₅O₉, etc. Metal nitrides for this application would include titanium nitride and molybdenum nitride and examples of metal carbides are titanium carbide and tungsten carbide. For some electrochemical cell applications it may be more suitable to convert the outer layers of a metal support/current collector (or a coated metal support/current collector) to the corresponding metal oxide (or mixed metal oxides) by heating the metal support/current collector in air (or oxygen) at a temperature in the range of 300° C. to 800° C. for a time in the range of 0.5 hours to 5 hours.

Alternatively, the gas diffusion electrode can be made by mixing Vulcan XC-72R high surface area carbon powder (CABOT) and carbon fibers (such as Thornel™ DKD-X manufactured by Amoco Corp., Apharetta, Ga.) with PTFE suspension (T-30, DuPont), in a range of 45-55 weight percent carbon powder, 13-21 weight percent carbon fibers and 25-35 weight percent polytetrafluoroethylene such as a 52:17:31 ratio (based on the dry weight of the PTFE), water, and nonionic surfactant (Triton X 100). Again, the carbon/PTFE mixture is sonicated and the resulting paste is pasted onto an appropriate metal support/current collector as described above.

Almost all gas diffusion layers comprise an electronically conducting support/current collector element where this element is either carbon cloth, carbon paper made from carbon fibers or a fluid permeable metallic-based material. However, for electrochemical stacks where the current passing through each cell in the stack is collected from at least one edge of a cathode electrode of a first cell and from the anode electrode of an adjacent cell, then a fluid permeable metallic based support/current collector is highly desirable and preferred. A sintered mass derived from fine carbon powder (or a mixture of carbon powder and carbon fibers) and polytetrafluoroethylene emulsion is bonded onto and/or impregnated into the support/current collector. If desired, an electrocatalyst layer comprising an ion exchange polymer electrolyte can be applied to one surface of the resulting gas diffusion electrode. The support/current collector and the impregnated and/or bonded sintered mass comprise a unitary structure.

Contacts formed between the surfaces of carbon powder particles and/or carbon fibers create a plurality of three dimensional hydrophilic pathways throughout the bulk of the pressed and sintered mass comprising a microporous gas diffusion electrode. The tortuous hydrophilic pathways extend from a surface to an opposite and substantially parallel surface of the sheet-like electrode. The hydrophilic pathways allow liquid water to be transported to, or away from, an ion exchange membrane/electrocatalyst interface in an electrochemical cell. Similarly, contacts formed between the surfaces of sintered polytetrafluoroethylene particles throughout the bulk of the pressed and sintered mass comprising a gas diffusion electrode create a plurality of three dimensional hydrophobic pathways that extend from a surface to an opposite and substantially parallel surface of the sheet-like electrode. The tortuous hydrophobic pathways allow gases or vapors to be transported to, or away from, an ion exchange membrane/electrocatalyst interface in an electrochemical cell. The hydrophilic pathways and the hydrophobic pathways can be randomly, or uniformly, distributed throughout the bulk of the microporous gas diffusion layer forming three dimensional networks.

The hydrophilic and hydrophobic pathways facilitate two phase (gas and liquid) flow to (or away from) an electrocatalyst/ion exchange membrane interface. In some instances gas and water flow in the same direction through the microporous gas diffusion electrode, while in other instances they flow in opposite directions. An optimum gas diffusion electrode structure and formulation provides a high activity or concentration of a reactant gas at an electrocatalyst/electrolyte interface even under high current density conditions (greater than 1 Acm⁻²) and where significant amounts of product water are formed such as when oxygen gas is reduced to liquid water in a PEM fuel cell. Transport of such product water by wicking action through the network of hydrophilic channels prevents saturation of the gas diffusion layer with liquid water. A gas diffusion structure having a substantially homogeneous distribution of hydrophobic and hydrophilic pathways is deemed important to facilitating liquid water transport through the diffusion structure in both directions, i.e., toward and away from the cathode electrocatalyst layer, depending upon the operating conditions of the stack. This produces a stack that functions well across a range of operating conditions, such as a range of current densities where the degree of water production and electroosmotic flow may vary considerably. Furthermore, air cooling of the stack by flowing excess air through fluid flow field channels and over the water retention barriers, may induce condensation of water vapor on the water retention barrier. Having a gas diffusion structure with substantially uniform hydrophilic and hydrophobic pathways allows this condensed liquid water to flow back to the ion exchange membrane/electrocatalyst interface to hydrate the membrane. Accordingly, improved water management is achieved without compromising the electrical conductivity and gas diffusion properties of the gas diffusion structure.

The liquid water retention barriers of the present invention may be either electronically conducting or electronically non-conducting (electronically insulating). While either an electronically conducting barrier or an electronically non-conducting barrier may be used in a bipolar, filter press-like electrochemical cell stack, there may be a need for accommodation in order to prevent interrupting necessary electronically conducting current pathways from cell-to-cell or preventing short circuiting of adjacent cells. Furthermore, the barriers may include electronically conducting regions and electronically nonconducting regions in various patterns. For example, a serpentine pattern may be used to match the channels of a serpentine flow field, such that the barrier includes regions contacting the lands made from electronically conducting material and regions between the lands (i.e., covering the channels) made from electronically non-conducting material. It is also anticipated that the density and pore size or permeability of the liquid water retention barrier may change over these regions, such as a higher density material contacting the lands and a more porous or permeable material over the channels.

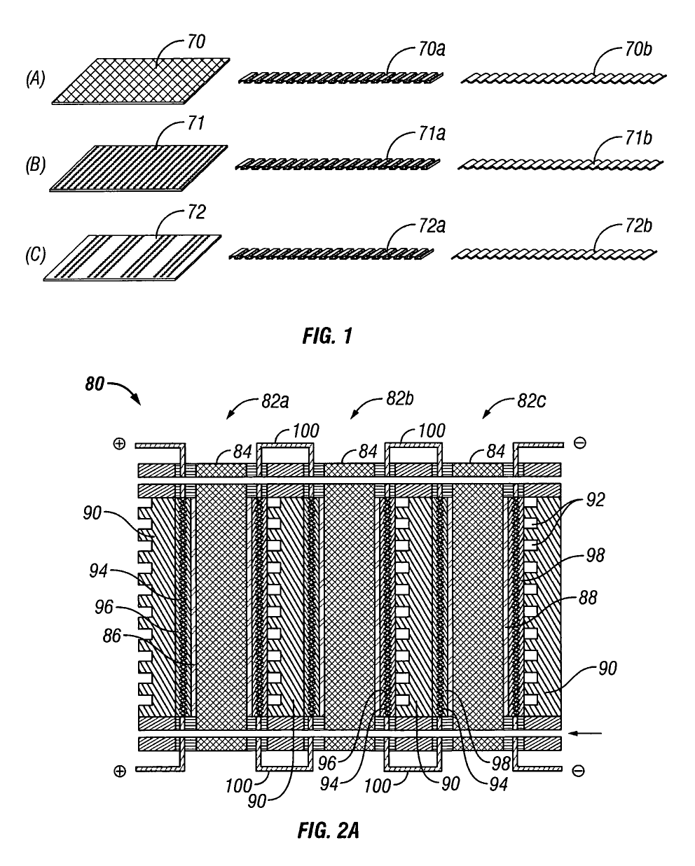

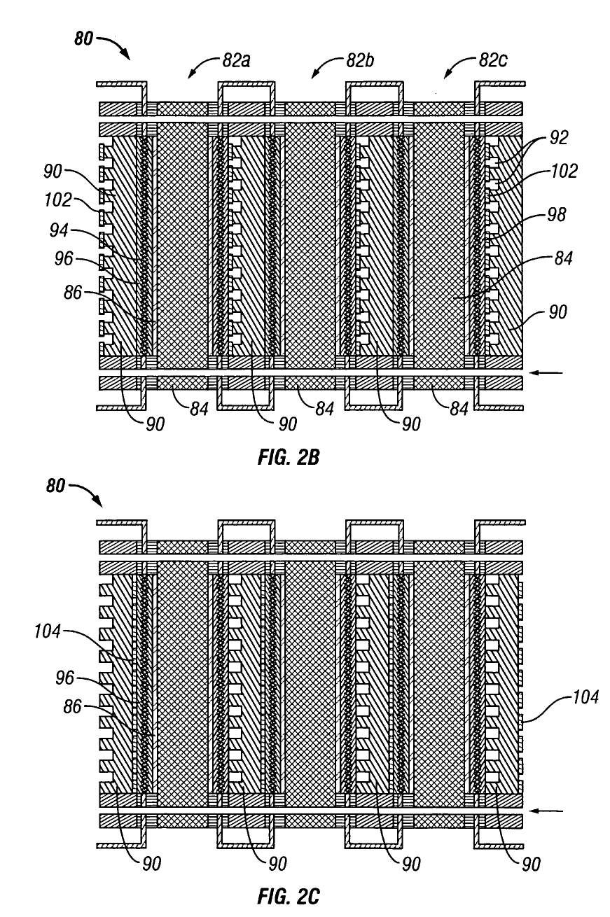

In one embodiment of the present invention, a porous, electronically conducting liquid water retention barrier is located at the back face of the gas diffusion structure (as shown in FIG. 2(b)). In this embodiment, the porous water retention barrier, in the form of a metal or metal alloy sheet, metal foil or open cell metal foam, also serves as a key component of the current collector, thereby permitting the use of wider channels in the flow field for reduced resistance to gas flow. Normally, such channels have widths in the range 0.5 mm to 1.0 mm. On including a suitably porous metal, metal alloy, or metal foam barrier, the widths of the channels can be increased by a factor of up to about three. A perforated metal, or metal alloy, barrier suitable for use in this embodiment is shown in FIG. 1(b). This figure shows a barrier for use in a variation of this embodiment where the portion of the barrier over the lands in the flow field is not perforated (see FIG. 1(c)). In this variation, the solid portion offers less electrical resistance than a comparable perforated portion. The reactant gas permeable barrier can be used as the porous bare metal, or the surface of the barrier (including the walls of holes or pores) can be modified to either increase or decrease the hydrophobicity, but the modification preferably increases the hydrophobicity. Examples of appropriate materials for increasing hydrophobicity are PTFE, PvDF and quasicrystals. If it is desired for the surface to have less hydrophobicity (i.e., more hydrophilic character), other modifications, such as treating the metal to produce a conductive oxide layer may be appropriate.

In one embodiment, a bipolar, filter press-like electrochemical cell stack will include an electronically conducting liquid water retention barrier in the stack to separate an electrode from a reactant gas stream (or product gas stream as the case may be). If the water retention barrier is added to a conventional bipolar, filter press-like stack, where each cell is internally electrically connected in series to an adjacent cell, without further modification, the barrier should be electronically conducting in order to pass electrons there through. Accordingly, an electronically conducting water retention barrier may be disposed in various places within the cell structure, since it will not disrupt the electronically conducting pathways necessary for electrons to flow from one cell to an adjacent cell. For example, the water retention barrier may be disposed immediately adjacent the electrocatalyst layer, within a gas diffusion layer, or between the gas diffusion layer and a flow field. While other arrangements may be possible, there is no essential need for a more sophisticated configuration.

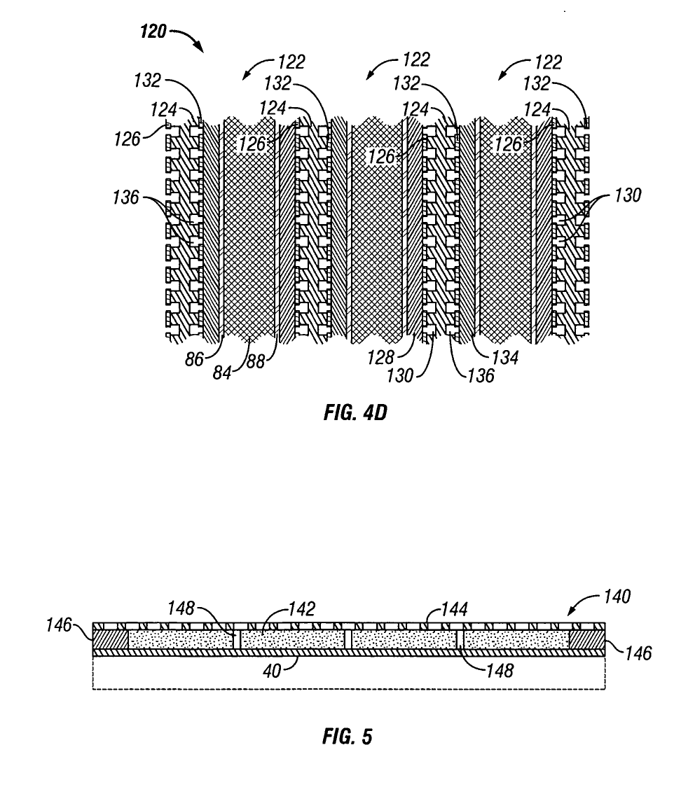

In a further embodiment, a bipolar, filter press-like electrochemical cell stack may include an electronically non-conducting liquid water retention barrier covering the electrocatalyst layer. However, placing an electronically non-conducting water retention barrier within a bipolar, filter press-like stack, without further accommodation, would tend to disrupt the necessary pathways for electron flow between adjacent cells. However, various techniques can be used to avoid this problem. For example, a suitable electronically conducting pathway may be maintained if electronically conducting elements of the reactant gas flow field pass through the electronically non-conducting water retention barrier to provide an electronically conducting pathway through the barrier (see FIG. 6).

Alternatively, the bipolar, filter press-like electrochemical cell stack may include a fluid permeable, electronically conducting current collector disposed on the cathode electrocatalyst side of the barrier, where the current collector extends at least to the edge of the electrochemically active area before providing electronic communication with the anode of an adjacent cell. (See FIG. 2(a)). In this manner, electrons may flow around the water retention barrier rather than through the barrier. One advantage of this technique is that the non-conducting liquid water retention barrier may be simply placed within the stack, such as between the reactant gas flow field and a gas diffusion layer. It should be recognized that the current collector may be variously positioned, including adjacent to the cathode electrocatalyst layer, within the gas diffusion layer, or on the backside of the gas diffusion layer. In any of the foregoing configurations, it is generally preferred that the water retention barrier extend over the entire active area of the cell, even more preferably forming a seal with framing members to prevent the water vapor or gases from going around the barrier.

A liquid water retention barrier of the present invention may be simply disposed adjacent or in intimate contact with an electrode, preferably a gas diffusion electrode, but the liquid water retention barrier may also be secured to an electrode in a manner that avoids deformation of the barrier. For example, when liquid water or water vapor is inhibited from passing through a barrier, pressure may build up against the barrier. Increased pressure and the accumulation of water may lead to a “bag effect” if the barrier is not suitably secured to the electrode structure. The barrier may be secured mechanically, but is preferably secured through adhesive bonding or hot pressing. Still further, the barrier may be formed within a gas diffusion layer or porous flowfield.

In still another embodiment of the present invention, a liquid water retention barrier is used to reduce the extent of water evaporation at the cathode while a surface parallel to the anode is simultaneously cooled. The anode may be cooled using a fluid-cooled bipolar plate. This causes water condensation to occur at the cooled anode surface and lowers the vapor pressure in the anode compartment below saturation at the anode temperature. The condensate may be collected and removed from the fuel cell stack for further use. Under these conditions, the rate of water evaporation from the anode increases, which reduces the relative concentration of liquid water at the anode electrocatalyst/membrane interface. This depletion in turn increases the rate of liquid water diffusion from the liquid water rich cathode to the anode through the proton exchange membrane solid polymer electrolyte. The net result is the extraction and collection of the excess water produced electrochemically in the cell through the anode.

Liquid water collection at the anode of an electrochemical cell in an electrochemical cell stack can be accomplished by a variety of means. The water can be collected by wicks, which then carry the water out of the cell. Alternatively, the water can be pushed out of each cell in the electrochemical cell stack by the reductant gas flow which can be made to flow continuously or periodically, that is in a purging mode. Still further, the liquid water can settle to the bottom of the electrochemical cell stack by gravity for collection, in which case, the flow of liquid water can be promoted by the cooled anode surface being hydrophilic. On a hydrophilic surface, the water will rapidly spread out and move over the surface with less resistance to flow than on a hydrophobic surface. The surface can be made hydrophilic by proper choice of material or by modifying the surface itself. Potential methods for modifying the surface include oxidizing a metal surface or applying a hydrophilic coating to any type of surface.

All of the foregoing descriptions have dealt with the use of a liquid water retention barrier to maximize the retention of liquid water and to minimize or control losses of water vapor at the anode side, and/or the cathode side, but preferably at the cathode side, of an electrochemical cell, in particular a bipolar, filter press-like fuel cell stack, and more particularly a bipolar, filter press-like PEM fuel cell stack. However, the present invention is not limited to the retention of water. The invention disclosed here can also be usefully applied to improve the performance of any electrochemical cell by giving rise to passive control, management, or collection, as the case may be, of a volatile component, e.g., an electrolyte, or product. These electrochemical cells specifically include bipolar, filter press-like fuel cell stacks using an anion exchange membrane, an alkaline solution, or alkaline gel as an electrolyte, or any aqueous solution as an electrolyte.

The retention barrier also advantageously protects the gas diffusion layers from plugging up with particulates from the air including particulate matter from the exhausts of internal combustion engines, such as diesel engines. Such particulate matter may have particle sizes in the range of 0.1 to 100 microns. Furthermore, the retention barrier protects the gas diffusion layers from clogging up with suspended particulate matter, such as silt or vegetative matter, on immersing the bipolar, filter press-like electrochemical cell stack in a lake, river, or other source of non-potable water.

Attachment or adhesion across the faces of the gas diffusion layers prevents sagging of the water retention barrier and assures that liquid water is maintained in close proximity to the PEM. Furthermore, having the water retention barrier in physical contact with the gas diffusion layer provides a continuous layer comprising continuous surfaces from the water retention barrier to the PEM so that the hydrophobicity of these surfaces can play a role in keeping liquid water near the PEM or driving liquid water back to the PEM.

FIGS. 1(a)-(c) are diagrams illustrating various geometrical configurations for water retention barriers of the present invention. Examples on the left are substantially flat, sheet-like water retention barriers for use with electrochemical cell stacks supplied with gaseous reactants. The retention barrier 70 is a microporous polymeric, metallic, ceramic, aerogel, or composite substrate having various thicknesses and being either hydrophobic or semihydrophobic. The other retention barriers 71,72 are non-porous polymeric, metallic, ceramic or composite substrates having various thickness. Retention barrier 71 is shown having a uniform distribution of through-holes and retention barrier 72 is shown having a non-uniform distribution of through-holes. The diameters and surface densities of the through-holes are selected based on whether the fuel cell is intended for operation at a low current density (i<200 mA cm⁻²), medium current density (200 mA cm⁻²<i<600 mA cm⁻²), or high current density (i>600 mA cm⁻²). If a retention barrier is made of a material that is not inherently hydrophobic, the barrier can be made hydrophobic or at least semihydrophobic by applying a layer or a film of hydrophobic material such as polytetrafluoroethylene, polyvinylidene fluoride or quasicrystals to at least one side of the substrate including the through-holes. The materials and configurations of the retention barriers 70,71,72 can be further modified, such as by providing barriers 70a,71a,72a with grooves or providing barriers 70b,71b,72b that are corrugated, respectively.

FIG. 2(a) is a schematic cross-sectional side view of a PEM bipolar, filter press-like fuel cell stack 80 having three fuel cells 82a,82b,82c each externally electrically connected in series by an electronically conductive element 100 to an adjacent cell. Each cell 82 includes a PEM 84 having an anodic electrocatalyst 86 and a cathodic electrocatalyst 88 disposed on opposite sides thereof. The stack 80 further includes separator plate/fluid flow field combination members 90 that may be electronically non-conducting or having reduced electrical conductivity at least in the axial direction of the fuel cell stack (left to right in the figure). The separator 90, which optionally may include a fluid cooled cooling plate, must prevent the mixing of anodic and cathodic reactants, such as hydrogen and oxygen. The flow fields 92 that cover the face of the separator 90, shown here only on the cathode side, but also present on the anode side as well (at right angles to the cathode side), may be formed in any known configuration, such as serpentine channels, foam having open cells, or posts. An explanation of post-type flow fields is found in U.S. patent application Ser. No. 10/448,974 filed on May 30, 2003, which application is incorporated by reference herein. While the terminal members 90 on the right and left of the stack 80 may be referred to as endplates, no particular distinction is being made here, although the external electrical connections of these endplates may be directly coupled to an electrical energy consuming device, such as a motor.

In order to accommodate electron transport from the anodic electrocatalyst 86 of a first cell 82c to the cathodic electrocatalyst 88 of an adjacent cell 82b, the separator 90 positioned between these cells includes, or is accompanied by, fluid permeable current collectors 94 extending over the active area of the cells. As shown, the current collectors 94 are disposed within the anodic gas diffusion layer 96 and the cathodic gas diffusion layer 98. Electrons liberated in the hydrogen oxidation reaction at the anodic electrocatalyst 86 pass, under an electrochemically induced potential, into the gas diffusion layer 96 and the current collector 94 therein. The current collectors 94 on opposing sides of the separator 90 are coupled by an electronically conducting member 100, such as a metal wire, metal bar or metal plate. Specifically, the member 100 can be the same material as the current collector 94. The electronically conducting member 100 allows the electrons to pass through the opposing current collector 94 and cathodic gas diffusion layer 98 to the cathodic electrocatalyst 88 where the electrons are consumed in the water-forming reaction with protons and oxygen. (In a hydrogen concentrator, the electrons and protons combine to form hydrogen gas). While the members 100 are shown extending around two sides of the separator, it should be appreciated that the invention encompasses members extending around all or part of the separator, such as around one or more sides of a rectangular separator. Furthermore, it is not necessary that the member 100 form the outermost boundary of the separator 90.

The bipolar, filter press-like fuel cell stack 80 is also provided with a hydrogen gas manifold for delivery of hydrogen gas to each of the anode flow fields (not shown) and an oxygen gas manifold for distribution of oxygen or air to each of the cathode flow fields. Suitable manifold arrangements are well known in the art.

FIG. 2(b) is a schematic cross-sectional side view of the bipolar, filter press-like fuel cell stack 80 of FIG. 2(a) having a water retention barrier 102 inserted into each cell 82a,82b,82c between the cathode gas diffusion layer 98 and the flow field 92 of the separator 90. The water retention barrier 102 can be either electronically conducting or electronically non-conducting. The retention barrier 102 serves the same functions as described previously. Namely, the retention barrier 102 has pores or holes that allow the passage of gas and water vapor between the flowfield 92 and the gas diffusion layer 98, but the pores or holes are small enough, are of sufficient density, and/or have sufficient hydrophobicity to limit or prevent the loss of liquid water from the gas diffusion layer 98 into the flowfield 92. It is highly preferred, but not necessary, that the barrier extend over the entire active area of the cell. However, the barrier is beneficial wherever drying may be a problem. While the pores or holes are preferably sized so that water vapor can pass through the retention barrier 102 into the flowfield 92 for withdrawal from the stack 80 to prevent flooding of the cathode, the barrier 102 prevents excessive evaporative water loss that can be caused by excessive gas flow rates through the flowfield 92. High gas flow rates may be desirable during operation of the fuel cell, for example to: (1) provide a volume of a reactant that is some multiple of the stoichiometric requirements, (2) provide cooling of the cell, (3) tolerate fluctuating flow rates caused by ambient conditions that are not directly controlled, (4) flush inerts, such as nitrogen, from the cell, or (5) remove undesirable reaction products from the cell. In accordance with the invention, the retention barrier 102 enables a fuel cell to enjoy the benefits of high gas flow rates without suffering from excessive evaporative water losses or, on the other hand, flooding. Both drying of the membrane and flooding of the electrodes can significantly hamper the performance of the stack. Rather, the barrier retains sufficient water in the cathode so that back diffusion toward the anode is generally sufficient to maintain appropriate hydration of the PEM, even over a wide range of oxidant flow rates, stack temperatures, and other operating variables.

Accordingly, the invention also includes a method of operating a bipolar, filter press-like fuel cell stack that has a water retention barrier 102 between the cathode gas diffusion layer 98 and the oxidant flow field 92 of each cell 82, the method including controlling the flow of oxidant through the fuel cell stack in order to maintain adequate hydration of the PEMs. Higher flow rates of the oxidant may cool the fuel cells and prevent excessive evaporation of water in the cathodes, resulting in reduced water losses in the form of water vapor through the water retention barriers. Conversely, lower flow rates of the oxidant may allow the fuel cells to operate at higher temperatures and cause additional evaporation of water in the cathodes, resulting in removal of greater amounts of water from the cathode as water vapor passing through the water retention barriers. Accordingly, the temperature of the fuel cells, and hence the water balance in the fuel cells, can be managed by controlling the oxidant flow rate. In order to monitor or automate this process, cell resistance or impedance may be used as a measure of proper PEM hydration, wherein higher cell resistance indicates drying. On the other hand, electrical current output from the fuel cell stack may be used as a measure of flooding.

FIG. 2(c) is a schematic cross-sectional side view of the bipolar, filter press-like fuel cell stack 80 of FIG. 2(a) having a water retention barrier 104 disposed between the anode gas diffusion layer 96 and the reductant flow field of the separator 90. As with the water retention barrier 102 at the cathode in FIG. 2(b), the water retention barrier 104 can be either electronically conducting or electronically non-conducting and can cover all or part of the anode active area.

FIG. 2(d) is a schematic cross-sectional side view of the bipolar, filter press-like fuel cell stack 80 of FIG. 2(a) having both the water retention barrier 102 on the cathode side of the PEM 84 between the cathode gas diffusion layer and the oxidant flow field of each cell and the water retention barrier 104 on the anode side of the PEM 84 between the anode gas diffusion layer and the reductant flow field of each cell. The water retention barriers can be either electronically conducting, electronically non-conducting, or a combination thereof. The configuration, material, and placement of the water barriers may differ from the anode and cathode and from cell to cell.

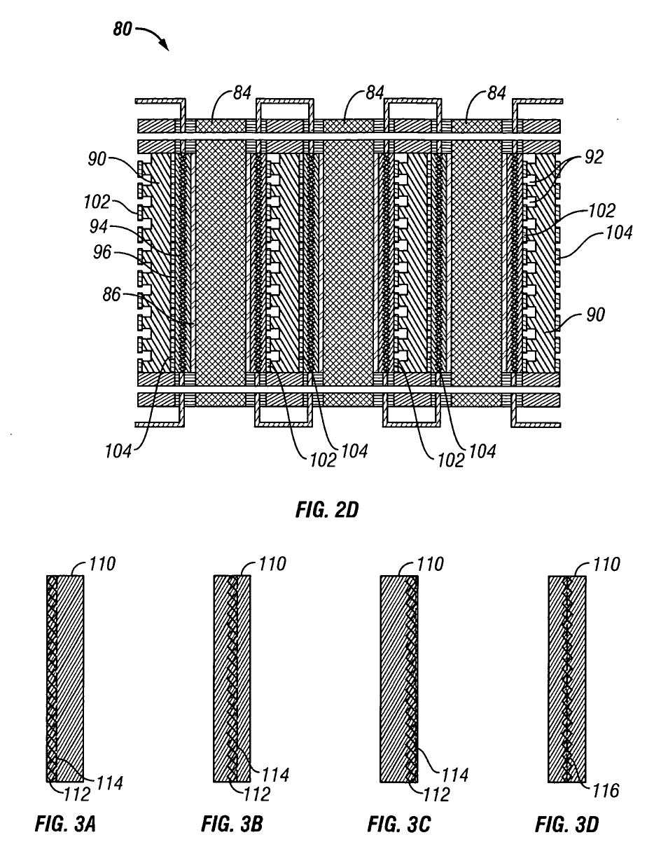

FIGS. 3(a)-(g) are schematic cross-sectional side views of various configurations of gas diffusion layers 110 suitable for incorporation in the bipolar, filter press-like fuel cell stack 80 of the types shown in FIGS. 2(a)-(d). FIGS. 3(a), 3(b), and 3(c) show gas diffusion layers 110 incorporating a fluid permeable current collector 112 and a water retention barrier 114 as two separate elements that are placed side-by-side or attached to each other, where at least the fluid permeable current collector element 112 is electronically conducting. FIG. 3(d) shows a gas diffusion layer 110 where the current collector 116 has voids that are impregnated or otherwise treated with a material that causes the collector 116, such as an expanded metal sheet, sheet of metal foam, or metal wire cloth to also function as a water retention barrier. FIGS. 3(e), 3(f), and 3(g) show gas diffusion layers 110 having an electronically conducting element 118, such as a thin metal sheet with through-holes, thin sheet of metal foam or metal wire cloth that both collects current and retains water.

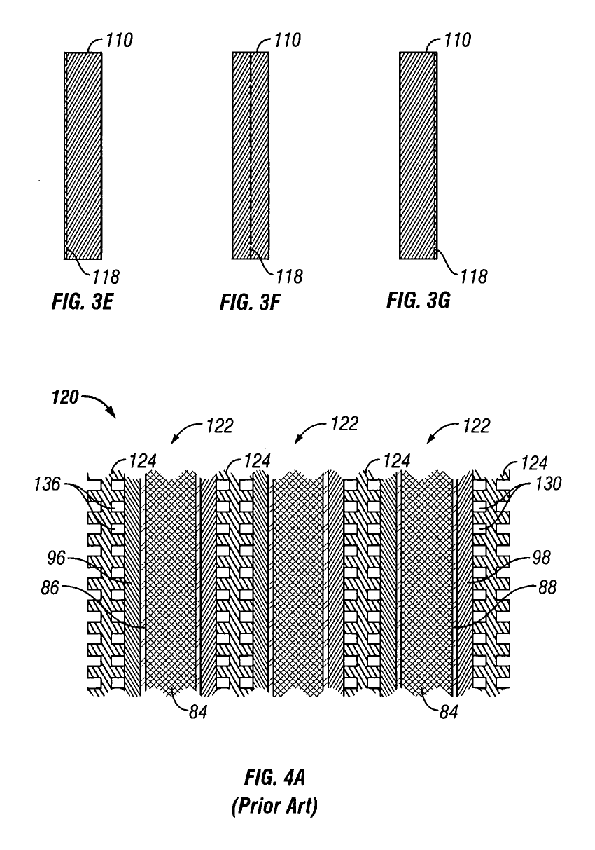

FIG. 4(a) is a schematic cross-sectional side view of segments of three adjacent fuel cells 122 from a PEM bipolar, filter press-like fuel cell stack 120 where each cell is internally electrically connected in series to an adjacent cell by an electronically conducting bipolar plate/fluid flow field/current collector assembly 124. The electronically conducting bipolar plate/flow field/current collector assembly optionally may include a fluid cooled cooling plate. As in previous Figures, each cell includes a PEM 84, an anodic electrocatalyst layer 86, an anodic gas diffusion layer 96, a cathodic electrocatalyst layer 88, and a cathodic gas diffusion layer 98.

FIG. 4(b) is a schematic cross-sectional side view of the bipolar, filter press-like fuel cell stack 120 of FIG. 4(a) having a water retention barrier 126 disposed in each cell 122 between the cathode gas diffusion layer 128 and the oxidant flow field 130. The water retention barrier 126 is electronically conducting at least over the lands of the oxidant flow field/current collector 124. While this configuration could also be used with a fluid permeable current collector in the gas diffusion layer 128, such as collector 94, and/or an external element 100, as in FIG. 2(a) they are not necessary.

FIG. 4(c) is a schematic cross-sectional side view of the bipolar, filter press-like fuel cell stack 120 of FIG. 4(a) having a water retention barrier 132 disposed in each cell 122 between the anode gas diffusion layer 134 and the reductant flow field 136.

FIG. 4(d) is a schematic cross-sectional side view of the bipolar, filter press-like fuel cell stack 120 of FIG. 4(a) having a water retention barrier 126 disposed between the cathode gas diffusion layer 128 and the oxidant flow field 130 of each cell 122 and a water retention barrier 132 disposed between the anode gas diffusion layer 134 and the reductant flow field 136. The water retention barriers are electronically conducting at least over the lands of the reductant flow field portion 136 and oxidant flow field portion 130 of the current collector 124.

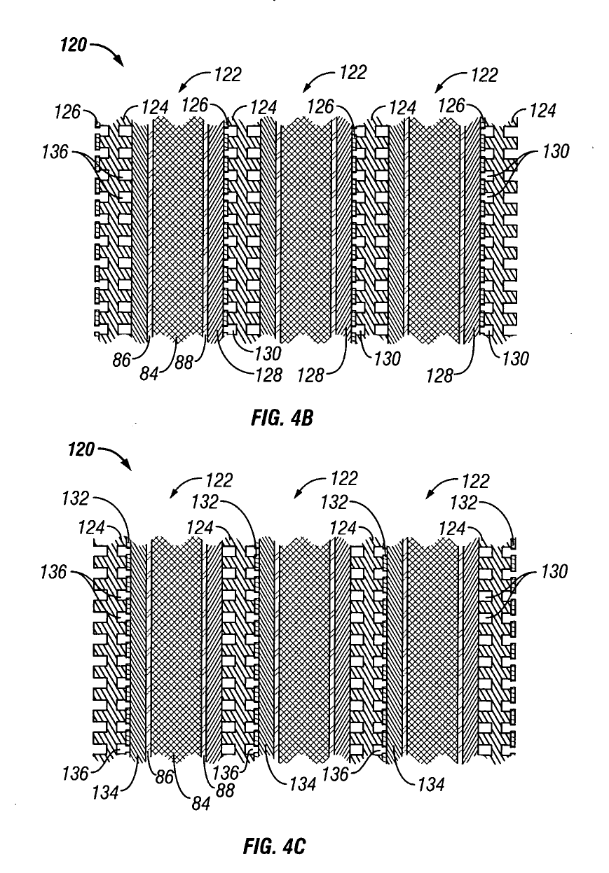

FIG. 5 is a cross-sectional side view of a subassembly 140 that includes a water retention barrier 40, an air filtration layer 142 and an optional macroporous or open structural support member 144. Preferably, the subassembly further includes one or more frames 146 or spacers 148 that provides the water retention barrier with additional support from member 144 and avoids excessive compression of the air filtration layer 142. The subassembly 140 is used adjacent an electrode with the water retention barrier 40 disposed against the electrode. For example, the subassembly 140 may be disposed against and cover the cathodic gas diffusion layer 98 of a bipolar, filter press-like fuel cell stack 80, comprising adjacent fuel cells 82a,b,c in the same manner as the water retention barrier 102 shown in FIG. 2(b).

The water retention barrier of the subassembly may be made from any of the materials previously described, such as: (i) a thin, gas permeable, liquid water impermeable membrane; (ii) a thin, porous sheet of material; or (iii) a thin, substantially solid sheet of material except for a plurality of small through-holes that penetrate through the sheet. These barriers may be treated or untreated as described previously.

The air filtration layer of the subassembly may be made from any materials known or suitable for filtering air. The primary purpose of filtering the air is to remove airborne particulate material before it can damage the operation of the cathode through such mechanisms as poisoning, physical blockage of pores in the water retention barrier or gas diffusion structure, or reducing the oxidant concentration. For example, the air filtration layer may be made from activated carbon, carbon fibers, carbon powder or carbon granules, single-walled or multi-walled carbon nanotubes, buckminsterfullerenes or “buckyballs” such as C₆₀, small particles of metal oxides (such as magnesium oxide or calcium oxide), or combinations thereof. The fibers, powders, granules, nanotubes, and particles of various materials may be mixed together in optimum ratios for a particular electrochemical cell application and may be held or bonded together by a cured polymeric binding agent. Optionally, the individual components, or mixtures of them may be impregnated into, or supported on macroporous carbon cloth or carbon felt, polymer cloth, polymer felt, or polymer foam having open cells. While the “filtration layer” preferably will physically trap particles, the material forming the layer may perform other functions, either alone or in combination with particulate filtration, such as adsorption or catalytic destruction of contaminants or other components other than the desired oxidant.

The filtration layer may be formed in a manner that performs the function of chemical or microorganism abatement or destruction. The performance of a fuel cell (or fuel cell stack) may be improved or maintained by removing or destroying one or more chemicals or microorganisms that the fuel cell is exposed to. For instance, the air available to an air cathode may contain volatile organic compounds (VOCs), gaseous inorganic compounds (such as hydrogen sulfide), a range of combustion exhaust gases (such as from an internal combustion engine, diesel engine, or fuel reformer), ozone gas (especially at high altitudes), bacteria, viruses, fungus and the like. The detrimental effects that these components can have on cell performance have gone largely unrecognized, because of the closely controlled conditions of many fuel cell studies and the short duration of operation. Catalysts suitable for many of these functions are described in U.S. Pat. Nos. 5,997,831; 6,190,627; 6,214,303; 6,375,905; 6,569,393; and 6,616,903, which patents are incorporated by reference herein.

Specifically, prolonged exposure of a fuel cell (or fuel cell stack) to air containing high levels of ozone may result in oxidation of carbon-containing structures in the gas diffusion layer or electrocatalyst support layer. Accordingly, the air contacting structures of the cell, such as the gas diffusion layer or air filtration layer, may include an ozone destruction catalyst, such as manganese dioxide, derivatives of manganese dioxide, carbon, and palladium or platinum supported on carbon. Alternatively, ozone adsorbents such as zeolites may be used.

Carbon monoxide gas (CO) in the air can also be potentially harmful to long term fuel cell performance, in particular under low operating temperatures, e.g. less than 30° C., or more importantly less than 10° C. under fuel cell start-up conditions. Under these low temperatures, CO readily adsorbs on active catalyst sites of the cathode electrocatalyst hindering adsorption of oxygen from the air on such sites, thus slowing the rate of oxidative removal of CO as a result of oxidation of CO to CO₂. Therefore, it may be beneficial to include a CO oxidation catalyst that, in the presence of air or oxygen gas, converts the carbon monoxide to carbon dioxide (CO₂). Exemplary catalysts include gold catalysts supported on metal oxide particles, such as high surface area titanium dioxide powder or tin dioxide powder. Suitable metal oxide-supported catalysts may be prepared by methods selected from co-precipitation, deposition-precipitation, and suspension spray reaction. While these catalysts are operable at cold temperatures, their higher performance at warm temperatures can be conveniently achieved in the air filtration layer due to the increase in the electrochemical cell temperature experienced during operation. Exemplary catalysts are described in U.S. Pat. No. 6,616,903, which patent is incorporated by reference herein.

The catalysts of the air filtration layer may themselves be protected against atmospheric contaminants by coating them with a porous protective material, such as an adsorbent. A hydrophobic material may be further applied over, or mixed with, the protective material to protect the catalyst from liquid water.

Organophosphorous compounds undergo destructive adsorption on magnesium oxide (MgO), wherein the phosphorus atoms become immobilized as a strongly bound residue. To be effective, adsorptive reagents must generally be finely divided, such as nanoparticles. Also, because the reactions of adsorptive reagents are non-catalytic, the reagents must be periodically replaced to remain effective. The preferred reagents are composites comprising finely divided particles of a first metal oxide selected from MgO, CaO, Al₂O₃, SnO₂, TiO₂ and mixtures thereof, these particles being at least partially coated with a second metal oxide selected from Fe₂O₃, Cu₂O, NiO, CoO and mixtures thereof. These composites most preferably comprise between 90 and 99 percent of the first metal oxide. These same adsorptive reagents may also be used to scavenge H₂S and/or CO₂ from the air or fuel streams to the fuel cell. Metal oxide or metal hydroxide adsorbents may be used alone or in combination, such as those adsorbents selected from MgO, CeO₂, CaO, TiO₂, ZrO₂, FeO, V₂O₅, V₂O₃, Mn₂O₃, Fe₂O₃, CuO, NiO, ZnO VAl₂O₃, SnO₂, Ag₂O, SrO, BaO, Mg(OH)₂, Ca(OH)₂, Al(OH)₃, Sr(OH)₂, Ba(OH)₂, Fe(OH)₃, Cu(OH)₃, Ni(OH)₂, Co(OH)₂, Zn(OH)₂, and AgOH. Most preferably, these adsorbents are powders prepared by aerogel techniques. Optionally, the adsorbents may have reactive atoms (such as chlorine, bromine or iodine) stabilized on their surfaces, species adsorbed on their surfaces, or coated with a second metal oxide.

Iron oxide magnesium oxide-composites are examples of finely divided composite materials that may be included in the air filtration layer in order to destroy chlorinated hydrocarbons (chlorocarbons) and chlorofluorocarbons. Preferably, the composites comprise a first metal oxide, such as MgO, coated with a thin layer of a transition metal oxide, such as Fe₂O₃. Materials and applications such as these are described in U.S. Pat. No. 5,712,219, which is incorporated by reference herein.

A fuel cell (or fuel cell stack) under prolonged or cyclic operation can experience microorganism contamination or fouling. Biofouling or biofilm formation is likely to be a problem for fuel cells using air (or enriched air) as an oxidant and that operate at temperatures in the range of 5° C. to 85° C., preferably 10° C. to 65° C., or more preferably 20° C. to 55° C., i.e., at temperatures close to physiological temperature 37° C. Accordingly, the microorganism affected surfaces of the fuel cell, in particular an air filtration layer if present, and/or the cathode gas diffusion layer, may contain an adsorbent uniformally dispersed throughout the layer, or may be coated with an adsorbent, such as MgO, CaO, Al₂O₃, ZrO₂, TiO₂, FeO, V₂O₅, V₂O₃, Mn₂O₃, Fe₂O₃, CuO, NiO, ZnO and mixtures thereof, wherein the adsorbent contains halogens, alkali metals or ozone. Microorganisms such as Bacillus Cereus, Bacillus Globigii, Chlamydia, Rickettsiae, fungi and viruses can be destroyed by contact with these adsorbents. Other chemical and biological agents may be similarly destroyed. Many of the materials and applications disclosed above are also described in U.S. Pat. Nos. 5,914,436; 5,990,373; 6,417,423; 6,653,519; 6,740,141; and 6,843,919, which patents are incorporated by reference herein.

Still further, the filtration layer and/or the water retention barrier may further remove or reduce the concentration of nitrogen that otherwise enters the cathode along with the oxygen.

It is preferred that the subassembly include a structural support member. A most preferred structural support member enables the subassembly to be integrated into a single composite article that is easy to handle. The structural support may take a number of forms and positions within the subassembly, but is preferably a rigid, macroporous structure disposed on the side of the subassembly that will face the air or oxidant stream. By disposing the structural support member to face the air supply, the support member can serve the additional function of providing the subassembly, and perhaps even the cell itself, with protection from physical impact or compression.

The subassembly 140 of FIG. 5 may be used in a bipolar filter press-like fuel cell stack through substitution of the subassembly for the water retention barrier 102 (for example, see FIG. 2(b)), but it is preferred to separate some of the functions and elements of the subassembly.

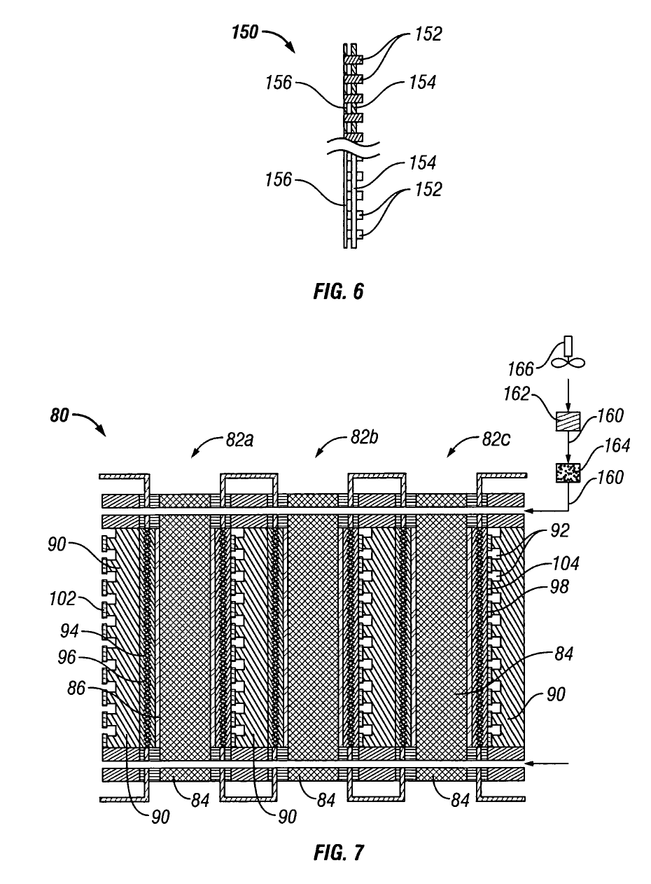

FIG. 7 is a schematic diagram of a bipolar filter press-like fuel cell stack 80 (as in FIG. 2(b)) with an air or oxidant supply line 160 in communication with the plurality of cathode flow fields 92 and cathodic electrocatalyst layers 88 through a common, external air filter 162. By providing an external air filter, the filter can be sized to avoid excessive pressure drop, can be changed or serviced with less effort, expense and cell downtime, and does not add to the overall cell electrical resistance, size, weight or design. Still, the air filter can be made of the materials previously described and serve the same functions. Optionally, the surface of the filter exposed to the untreated ambient air is made hydrophobic either by placing a thin porous sheet of hydrophobic material, e.g., PTFE or PvDF, over the surface of the filter or by applying by means of brush-coating or spraying a film of hydrophobic material, e.g., PTFE or PvDF, onto the exposed outer surface. As shown, the oxidant supply line 160 preferably will also include an air mover 166, such as a fan, blower or compressor. The air mover is optionally electrically operated. Furthermore, another optional embodiment further includes a chemical and/or microbiological abatement or destruction media 164, such as in the form of porous granules or pellets either supported (or non-supported) by means of a porous (or non-porous) support material as is well known for catalyst supports, e.g., alumina, and contained in a suitable polymeric or metallic housing. Alternatively, the chemical and/or biological abatement or destruction media may be applied as a layer or thin film on the walls of the cells of polymeric, ceramic, or metallic honeycomb-like support structures. The application of such layers and such honeycomb-like support structures are well known in the art of making catalytic converters for treating and purifying exhaust gas streams from internal combustion engines. Honeycomb-like support structures suitably treated, such as by wash-coating with chemical and/or biological abatement and/or destruction media, are placed in appropriate polymeric or metallic housings having an ambient air input port and a purified air output port. Preferably, the media will cause no more than a small pressure drop in the supply line. When the air filter media and the chemical and/or microorganism abatement or destruction media are separate, it is preferred to put the abatement or destruction media downstream of the filter media. Further, depending on the application of the fuel cell stack it may be advantageous to interpose an air, or enriched air, heat and humidity exchanger between the chemical and/or biological abatement or destruction media and the bipolar, filter press-like fuel cell stack. A suitable heat and humidity exchanger is described in U.S. patent application Ser. No. 11/030,600 filed on Jan. 6, 2004 which application is incorporated by reference herein.

FIG. 6 is a side view of a bipolar separator plate/fluid flow field/current collector assembly 150 for use in a bipolar filter press-like electrochemical cell stack, shown in partial cross-section. The bipolar separator plate/fluid flow field/current collector assembly 150 is shown comprising an array of electronically conducting posts 152 that are positioned to extend between an anode of a first electrochemical cell and a cathode of a second adjacent electrochemical cell. A gas impermeable barrier 154 extends between the posts 152 in order to prevent fuel and oxidant gases in the adjacent electrode chambers from mixing. An electronically non-conducting liquid water retention barrier 156 in accordance with the present invention is disposed within one of the flowfields formed by the posts 152, most preferably the cathode flowfield. More particularly, the electronically conducting posts 152 of the reactant gas flow field extend through the electronically non-conducting water retention barrier 156 to provide an uninterrupted electronically conducting pathway from one electrochemical cell through the barrier 156 to the other electrochemical cell. It is believed to be important to position the barrier 156 so that when it is assembled into a stack, such as by substituting the bipolar separator plate/fluid flow field/current collector assembly 150 for the bipolar plate/fluid flow field/current collector assembly 124 of FIG. 4(b), it makes face-to-face contact with an adjacent gas diffusion layer. This positioning of the barrier prevents pockets between the barrier and gas diffusion layer from collecting water. In addition, this positioning of the barrier does not significantly reduce the effective volume of the flowfield channels or passageways so that the resistance to gas flow through the flowfield is not affected.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. For example, the phrase “a solution comprising a phosphorus-containing compound” should be read to describe a solution having one or more phosphorus-containing compound. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made in the preferred embodiments of the present invention without departing from its true spirit. The foregoing description is provided for purposes of illustration only and should not be construed in a limiting sense. Only the language of the following claims should limit the scope of this invention.

1. A bipolar, filter press-like electrochemical cell stack comprising:
a plurality of electrochemical cells stacked one behind the other, each cell comprising an ion-conducting membrane with an anode electrocatalyst layer and a cathode electrocatalyst layer disposed on opposing sides of the membrane, a cathode gas diffusion structure disposed on the cathode electrocatalyst layer, an anode gas diffusion structure disposed on the anode electrocatalyst layer, and a gas permeable, liquid water impermeable water retention barrier having a first surface extending across a major portion of the active area of the cathode electrocatalyst layer, and a second surface extending across at least the channels of a cathode fluid flow field; and
one or more bipolar assemblies comprising an anode fluid flow field, a gas separator plate and a cathode fluid flow field, each bipolar assembly being disposed in electronic communication between adjacent electrochemical cells in the stack;
wherein the water retention barrier reduces the loss of liquid water from the cathode into the cathode fluid flow field.

2. The bipolar, filter press-like electrochemical cell stack of claim 1, wherein the electrochemical cell stack is a fuel cell stack.

3. The bipolar, filter press-like electrochemical cell stack of claim 2, wherein the cathode electrocatalyst layers are in collective fluid communication with ambient air through air filtration media.

4. The bipolar, filter press-like electrochemical cell stack of claim 2, wherein the cathode electrocatalyst layers are in collective fluid communication with ambient air through air filtration media and a second media selected from chemical abatement media, microorganism abatement media, or a combination thereof.

5. The bipolar, filter press-like electrochemical stack of claim 1, wherein the electrochemical cell stack is a hydrogen concentrator stack.

6. The bipolar, filter press-like electrochemical cell stack of claim 1, wherein the water retention barrier is electronically conducting at least over the lands of the cathode fluid flow field and the bipolar assembly is electronically conducting at least in the axial direction of the fuel cell stack.

7. The bipolar, filter press-like electrochemical cell stack of claim 6, wherein the electronically conducting bipolar assembly electronically connects adjacent cells in series internally to the stack.

8. The bipolar, filter press-like electrochemical cell stack of claim 1, wherein the bipolar assembly is electronically nonconducting in the axial direction of the electrochemical cell stack, and wherein the electrochemical cell stack further comprises;
a fluid permeable electronically conducting cathode current collector disposed between the cathode electrocatalyst layer and the water retention barrier of each electrochemical cell
a fluid permeable electronically conducting anode current collector disposed between the anode electrocatalyst layer and the anode fluid flow field of each cell, and
an electronically conducting element extending from the cathode current collector of a first electrochemical cell and around the water retention barrier to the anode current collector of a second electrochemical cell.

9. The bipolar, filter press-like electrochemical cell stack of claim 8, wherein the cathode current collector of a first electrochemical cell, the anode current collector of a second electrochemical cell and the electronically conducting element that extends from the cathode current collector to the anode current collector around the water retention barrier, electronically connects adjacent cells in series externally to the stack.

10. The bipolar, filter press-like electrochemical cell stack of claim 8, wherein the water retention barrier is disposed within the gas diffusion layer.

11. The bipolar, filter press-like electrochemical cell stack of claim 1, wherein the water retention barrier is disposed between the cathode gas diffusion layer and a cathode fluid flow field.

12. The bipolar, filter press-like electrochemical cell stack of claim 1, further comprising:
an electronically conducting bipolar plate/fluid flow field/current collector assembly having elements that extend through the water retention barrier into electronic communication with the cathode.

13. The bipolar, filter press-like electrochemical cell stack of claim 1, farther comprising:
a fluid permeable electronically conducting cathode current collector disposed in electronic communication with the cathode gas diffusion layer, wherein the current collector extends beyond the edge of the electronically insulating water retention barrier to provide electronic communication with a fluid permeable electronically conducting anode current collector of an adjacent cell.

14. The bipolar, filter press-like electrochemical cell stack of claim 1, further comprising means for cooling the anode to a temperature that is less than the temperature of the cathode.

15. The bipolar, filter press-like electrochemical cell stack of claim 1, wherein the bipolar assembly is a fluid cooled bipolar assembly.

16. The bipolar, filter press-like electrochemical cell stack of claim 12, further comprising a means for recovering water from a fuel gas exhaust stream.

17. The bipolar, filter press-like electrochemical cell stack of claim 1, wherein the anode electrocatalyst layer of each electrochemical cell is not covered by a water retention barrier.

18. The bipolar, filter press-like electrochemical cell stack of claim 1, further comprising:
a source of a hydrogen-containing gas in fluid communication with the anode of each electrochemical cell.

19. The bipolar, filter press-like electrochemical cell stack of claim 2, wherein the cathode reactant gas is selected from air, oxygen enriched air, oxygen, chlorine or bromine.

20. The bipolar, filter press-like electrochemical cell stack of claim 2, wherein the cathode reactant gas is ambient air.

21. The bipolar, filter press-like electrochemical cell stack of claim 1, wherein the water retention barrier is selected from a thin gas permeable liquid water impermeable membrane, a thin porous sheet of material, or a thin sheet of material that is substantially solid except for a plurality of small through-holes that penetrate from one side of the sheet to an opposing side of the same sheet, and combinations thereof.

22. The bipolar, filter press-like electrochemical cell stack of claim 1, wherein the water retention barrier has a thickness between 0.1 and 300 micrometers.

23. The bipolar, filter press-like electrochemical cell stack of claim 1, wherein the water retention barrier has an average pore size between 20 and 500 nanometers.

24. The bipolar, filter press-like electrochemical cell stack of claim 1, wherein the water retention barrier has an average pore size between 30 and 200 nanometers.

25. The bipolar, filter press-like electrochemical cell stack of claim 1, wherein the water retention barrier includes a component selected from porous polymer sheet or film, expanded polymer sheet or film, filter paper, perforated polymer sheet or film., polymer felts, and combinations thereof.

26. The bipolar, filter press-like electrochemical cell stack of claim 1, wherein the water retention barrier includes a material selected from porous thermoplastic sheet or film, expanded PTFE sheet or film, non-halogenated thermoplastic sheet or film, and combinations thereof.

27. The bipolar, filter press-like electrochemical cell stack of claim 1, wherein the water retention barrier includes a non-halogenated thermoplastic sheet or film selected from polyethylene, polypropylene, polystyrene, polycyclopentadiene, polyester, polycarbonate, polyethersulfone, polyimides, nylons, and combinations thereof.

28. The bipolar, filter press-like electrochemical cell stack of claim 25, wherein the water retention barrier is a composite comprising a modifier selected from carbon powder, powdered metal, and combinations thereof.

29. The bipolar, filter press-like electrochemical cell stack of claim 28, wherein the composite is electronically conductive.

30. The bipolar, filter press-like electrochemical cell stack of claim 15, wherein the water retention barrier includes a halogenated thermoplastic sheet or film selected from polytetrafluoroethylene (PTFE), polyvinylidene fluoride (PvDF), polyvinylflouride (PVF), polyvinylchloride (PVC), and combinations thereof.

31. The bipolar, filter press-like electrochemical cell stack of claim 30, wherein the water retention barrier is a composite comprising a modifier selected from carbon powder, powdered metal, and combinations thereof.

32. The bipolar, filter press-like electrochemical cell stack of claim 31, wherein the composite is electronically conductive.

33. The bipolar, filter press-like electrochemical cell stack of claim 1, wherein the water retention barrier includes a component selected from perforated metal sheet or foil, etched metal sheet or foil, expanded metal sheet or foil, porous sintered metal fritt, metal felt, metal foam comprising open cells, porous metal oxide sheet, ceramic fritt, ceramic felt, perforated ceramic sheet, carbon aerogel, resorcinol-formaldehyde aerogel, and combinations thereof.

34. The bipolar, filter press-like electrochemical cell stack of claim 33, wherein the water retention barrier comprises a metal selected from titanium, aluminum, magnesium, copper, nickel, cobalt, tin, alloys thereof, and combinations thereof.

35. The bipolar, filter press-like electrochemical cell stack of claim 33, wherein the water retention barrier comprises a metal alloy selected from stainless steel, carbon steel, brass, aluminum alloys, magnesium alloys, and combinations thereof.

36. The bipolar, filter press-like electrochemical cell stack of claim 33, wherein the retention barrier comprises a porous metal that is plated or coated with a metal selected from nickel, tin, gold, silver, platinum, ruthenium, iridium, palladium, alloys thereof, and combinations thereof.

37. The bipolar, filter press-like electrochemical cell stack of claim 1, wherein the water retention barrier is a composite including a metal and an oxide.

38. The bipolar, filter press-like electrochemical cell stack of claim 1, wherein the water retention barrier is hydrophobic.

39. The bipolar, filter press-like electrochemical cell stack of claim 1, wherein the water retention barrier is electronically conducting.

40. The bipolar, filter press-like electrochemical cell stack of claim 1, wherein the water retention barrier is electronically insulating.

41. In a bipolar electrochemical cell stack comprising:
a plurality of electrochemical cells stacked one behind the other, each cell comprising an ion-conducting membrane with an anode electrocatalyst layer and a cathode electrocatalyst layer disposed on opposing sides of the membrane, a cathode gas diffusion structure having a substantially uniform distribution of hydrophobic and hydrophilic pathways disposed on the cathode electrocatalyst layer, an anode gas diffusion structure disposed on the anode electrocatalyst layer;
one or more bipolar assemblies comprising an anode fluid flow field, a gas separator plate and a cathode fluid flow field, each bipolar assembly being disposed in electronic communication between adjacent electrochemical cells in the stack;
the improvement comprising:
a gas permeable, liquid water impermeable water retention barrier disposed in contact with the cathode gas diffusion structure and adjacent the cathode fluid flow field to reduce the loss of liquid water from the cathode into the cathode fluid flow field.

42. A method of operating an electrochemical cell having an anode and a cathode in contact with opposing faces of an ion conducting membrane, comprising:
supplying hydrogen gas to the anode;
passing a gas through a gas permeable, liquid water retention barrier covering the cathode;
withdrawing water vapor from the cathode through the water retention barrier;
preventing the passage of liquid water through the water retention barrier; and
allowing liquid water from the cathode to hydrate the membrane.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. A subassembly for a bipolar, filter press-like fuel cell stack, comprising:
air filtration media, wherein the cathode electrocatalyst layer of each electrochemical cell in the bipolar, filter press-like stack are in collective fluid communication with ambient air through the air filtration media.

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)
